(19) United States
(12) Patent Application Publication
(10) Pub. No.: US 2004/0019875 A1
(43) Pub. Date: Jan. 29, 2004

(54) Masked edit control for use in a graphical programming environment

(76) Inventor: Keith C. Welch, Harwich, MA (US)

Correspondence Address: CESARI AND MCKENNA, LLP, 88 BLACK FALCON AVENUE, BOSTON, MA, 02210, US

(21) Appl. No.: 10/424,320

(22) Filed: Apr. 28, 2003

Related U.S. Application Data
(60) Provisional application No. 60/376,131, filed on Apr. 29, 2002.

(51) Int. Cl. G06F 9/44; G09G 5/00; G06F 9/46

(52) U.S. Cl. 717/109; 717/113; 345/763; 719/328

(57) ABSTRACT

A masked edit program object for use in a graphical program-development environment is configured to have an Allow_Literal_Entry property that may be set as true or false, and an Insert_Zeros property that may also be set to true or false. If the Allow_Literal_Entry property is set to true, then at run-time when the program user enters a literal, the program object does not reject the literal as invalid entry, but rather searches the input mask for the entered literal and moves the cursor to the location in the input mask that is adjacent to the located literal. If the Insert_Zeros property is set to true, the program object will enter leading or trailing zeros in empty entries of the input mask that have been configured with specially-defined symbols for accepting leading or trailing zeros.

### CROSS-REFERENCE TO RELATED APPLICATIONS

The present application claims the benefit of U.S. Provisional Patent Application Serial No. 60/376,131, which was filed on Apr. 29, 2002, by Keith Welch for a Masked Edit Controller for Use in a Graphical Programming Environment, and is hereby incorporated by reference in its entirety.

The present application is related to the following U.S. patent applications:

U.S. patent application Ser. No. 09/483,760 entitled, METHOD AND APPARATUS FOR RESOLVING DIVERGENT PATHS IN GRAPHICAL PROGRAMMING ENVIRONMENTS, filed Jan. 14, 2000, now U.S. Pat. No. 6,425,121; and

U.S. patent application Ser. No. 09/483,122 entitled, REPEATING PROGRAM OBJECT FOR USE WITH A GRAPHICAL PROGRAM-DEVELOPMENT SYSTEM, filed Jan. 14, 2000, now U.S. Pat. No. 6,425,120,

which are hereby incorporated by reference in their entireties.

### BACKGROUND OF THE INVENTION

1. Field of the Invention

The present invention relates generally to the field of computer programming and, more specifically, to software development environments.

2. Background Information

To generate a software program that can be executed or run by a computer, a software developer or programmer typically chooses a programming language, such as BASIC (Beginner's All-purpose Symbolic Instruction Code), Fortran, C, etc., and writes source code using the keywords, syntax, variable names, data structures, etc. defined by the selected programming language. Each programming language typically defines its own unique syntax and keywords for performing various functions. After the source code has been written, it is typically converted by a compiler into a machine readable format that can be understood by the computer (e.g., object code). If the developer used incorrect keywords or syntax, the source code cannot by compiled successfully.

The source code is typically written with a text editor and organized into a series of lines of code. Although simple programs may only need a few lines of code, complex programs often consume hundreds, thousands or tens of thousands of lines of code. Significant portions of code, moreover, are often required just to generate displayable user interface images or forms, such as text boxes, command buttons, etc. that can be displayed by windows-based computer systems, such as personal computers running the Microsoft Windows® series of operating systems from Microsoft Corporation of Redmond, Wash. Furthermore, significant editing is often required to make even relatively minor adjustments to such user interface elements (e.g., moving, re-sizing, etc.).

In order to simplify the creation of such user interface images or forms, Microsoft developed and released a programming system known as Visual Basic®. Visual Basic includes a language engine for executing text-based programming statements, and a forms layout package having a plurality of objects or icons representing common user interface elements, such as text boxes, radio buttons, command buttons, scroll bars, etc. When a developer selects one of these objects from a tool palette and places it onto a form window, Visual Basic automatically creates corresponding code to support that object. By eliminating the need to write code just to display conventional interface elements, Visual Basic greatly simplified the creation of programs to be run on Windows-based platforms. These objects are typically stored in one or more dynamic link libraries (DLLs) that are loaded and run as necessary at application run-time. Since Visual Basic is an “open” programming languages, meaning that its syntax and command structures are known and available, third-parties have created and marketed a whole range of objects that can be added to a Visual Basic forms window to facilitate the creation of all sorts of different application programs.

With the release of Visual Basic 4.0, Microsoft extended Visual Basic to support software constructs that have certain object-oriented features by basing this release on its Component Object Model (COM). With Visual Basic 4.0, a new type of object, often referred to as a COM or ActiveX control or object was defined. A COM or ActiveX control is basically a component program object based on Microsoft's COM technologies, which can issue or raise events. With Visual Basic 4.0 and later releases, a developer similarly uses a forms layout package to drag and drop one or more ActiveX controls onto a form window. In addition, by double-clicking an ActiveX control on the form window, a code window is displayed. Inside this code window, the developer may insert text-based programming code to handle the events raised by the respective ActiveX control (i.e., an event handler). This code must comply with the syntactical and keyword constraints defined by Visual Basic in order for it to be properly executed at application run-time. By writing these event handlers, a developer can cause various ActiveX controls to share information and otherwise interact with each other greatly facilitating the creation of application programs.

FIG. 1 illustrates a conventional Visual Basic work space 100 that may be displayed on a computer screen. The work space 100 includes a Form window 102 and a tool palette 104. The tool palette 104 contains a plurality of icons, which represent individual controls, including a vertical scroll control 106 and a text label control 108, among others. A developer may select any of the controls contained on palette 104 to cause the selected control to appear on the Form window 102. By selecting the vertical scroll icon 106, for example, a corresponding vertical scroll image 110 is displayed on the Form window 102. A text label image 112 may be placed on the Form window 102 in a similar manner. At this point, however, there is no inter-relationship between the objects corresponding to vertical scroll image 110 and text label image 112. In order to establish some such relationship (e.g., causing the text label to display the current position of the vertical scroll), the developer must write a subroutine (e.g., an event handler). Each line or statement of the subroutine, moreover, must conform to the syntax and keyword commands of the underlying programming language (e.g., Visual Basic). Specifically, the developer selects the vertical scroll 110, thereby causing a code window 114 to be displayed on screen 100. Inside the code window 114, the developer writes a text-based subroutine 116 that causes the output of the vertical scroll 110 to be displayed in the text label 112.

When this program is subsequently run, images for the vertical scroll bar 110 and the text label 112 will appear on the screen of the user as part of a user interface. The text label 112, moreover, will display the position of the vertical scroll bar 110 (e.g., “2256”). If the user moves the slider bar of the vertical scroll, the contents of text label change to display the scroll bar's new position (e.g., “3891”). As shown, with Visual Basic, the developer need not “write” any code to cause the vertical scroll bar image 110 or the text label image 112 to be displayed on the computer screen during run time. In addition, during the programming phase, the developer may move and re-size these user interface elements simply by manipulating their appearance on the Form window 102 (e.g., with a mouse) in a conventional manner. Due to the relative ease with which application programs having user interface elements can be created, Visual Basic has become a highly popular programming tool. However, in order to develop a meaningful application program (i.e., one in which there is some inter-relationship between the user interface elements), the developer must write, in a text-based format, one or more subroutines.

Thus, the developer must learn and is limited by the syntax and keyword structures of Visual Basic.

Another user interface element provided by Visual Basic is a Masked Edit control. A masked edit control provides restricted data input as well as formatted data output. It is typically configured to supply visual cues about the type of data being entered or displayed. For, example, the Masked Edit control can be used to define the following input mask: “(___) ___-____” to prompt a user to enter a telephone number with area code. As the user enters information into the mask, the insertion point automatically jumps over any literals. Each character position of the input mask that has been defined maps to either a placeholder of a specified type, e.g., a digit or a letter, or to a literal character. Literal characters are the symbols used to give the user visual cues about the type of data that is being requested. In the above example, the parentheses and the hyphen are literals. In addition, special characters may be used in the input mask as placeholders for particular kinds of user input. For example, the pound symbol, “#”, is a required digit placeholder. The user must enter a digit, e.g., 0-9, at the location of the pound symbol. The question mark, i.e., “?”, is a required letter placeholder. The user must enter a letter (upper or lower case) at the location of the question mark.

In addition to Visual Basic and its related products (e.g., Visual C++, etc.), several companies have created software development tools that are almost entirely visually oriented. That is, using these tools, a developer can create an executable application program without having to write a single line of text-based code. For example, National Instruments Corporation of Austin, Tex. has created a programming tool called Lab-VIEW™ for creating virtual instruments primarily for use in the instrumentation industry. Hewlett Packard Company of Palo Alto, Calif. has similarly created a programming tool called HP VEE for generating software programs for use in the electronic testing and data acquisition industries.

HP VEE provides a work area in which a developer can create a data flow diagram. The developer typically selects the objects for inclusion in his or her program from a pull-down menu. HP VEE provides a fixed number of these objects which have been tailored to provide functionality commonly used in the data acquisition industry. The developer may then “draw” data lines between these objects in the work area. In response to drawing these lines, HP VEE creates program steps that transfer data or other information between the respective objects. The developer must perform all of this graphically within the work area.

### SUMMARY OF THE INVENTION

Briefly, the invention relates to a masked edit program object for use in developing application programs through a program-development environment. Using the program-development environment, a developer graphically specifies a flow diagram that represents the logical operation of the application program. The masked edit program object, which may have a corresponding icon for display within the flow diagram and a second symbolic representation for display during application run-time, is a user-interface object configured to perform restricted data input and formatted output. Using the masked edit program object, a program developer can define an input mask where each position in the input mask is either a placeholder of a specified character type or to a literal. Literals provide visual cues to the user regarding the type of data that is being requested during run time. They are not replaced as the user enters data. In the illustrative embodiment, the decimal point, the thousand separator, e.g., a comma, the date separator, e.g., a forward slash, and the time separator, e.g., a colon, are all literals. The masked edit program object also has a plurality of properties, including an Allow_Literal_Entry property that may be set as true or false, and an Insert_Zeros property that may also be set to true or false.

If the masked edit program object's Allow_Literal_Entry property is set to true, then at run-time when the application program user enters a literal, such as the forward slash, the program object does not accept the literal as an entered character or consider it an invalid entry given the current location of the insertion point within the input mask. Instead, the masked edit program object searches for the next occurrence of the literal that was entered by the user within the input mask. Upon finding the next occurrence of the literal, the masked edit program object jumps over the literal and places the insertion point immediately after the located literal. If the Allow_Literal_Entry property is set to false, the program object does not jump to another location and instead ignores the entry of any literals by the program user. If the Insert_Zeros property is set to true, the program object will adjust for leading or trailing zeros during data entry by the program user. That is, the program object will generate zeros, even though the user did not enter such values. If the Insert_Zeros property is set to false, the program object will not insert leading or trailing zeros.

The masked edit program object also has at least two outputs. A first output corresponds to the current format of the input mask in its entirety, including any valid user input, added zeros, provided that the object's Insert_Zero property is set to true, and any literals in the input mask. A second output provides only the data entered by the program user together with any added zeros, provided that the Insert_Zero property is set to true. The outputs of the program object may be coupled to other program objects, such as database controls, so that data entered by the program user may be stored at one or more databases.

### BRIEF DESCRIPTION OF THE DRAWINGS

The invention description below refers to the accompanying drawings, of which:

FIG. 1, previously discussed, is a highly schematic illustration of a conventional visual programming environment;

FIG. 2 is a computer system configured in accordance with the present invention;

FIG. 3 is a highly schematic illustration of the software components of the computer system of FIG. 2;

FIGS. 4A-4D are preferred illustrations of a graphical user interface in accordance with the present invention;

FIG. 5 is a highly schematic block diagram of a data structure for use with the present invention;

FIGS. 6A-6B and 7 are flow diagrams of preferred methods of the present invention;

FIGS. 8A and 8B are preferred illustrations of the graphical user interface including a window for receiving textual inputs;

FIGS. 9A-9E are preferred illustrations of a graphical user interface including the masked edit icon of the present invention; and

FIGS. 10A-10I and 11A-11I are preferred illustrations of a run-time application window illustrating the operating characteristics of the masked edit program object of the present invention.

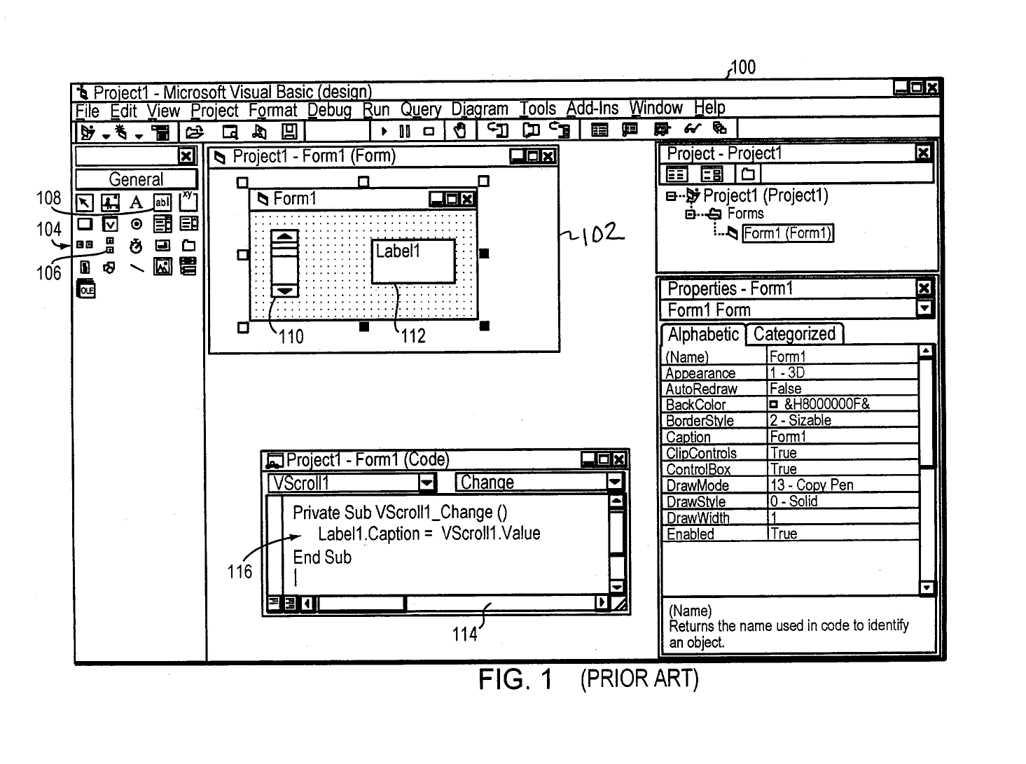

### DETAILED DESCRIPTION OF AN ILLUSTRATIVE EMBODIMENT

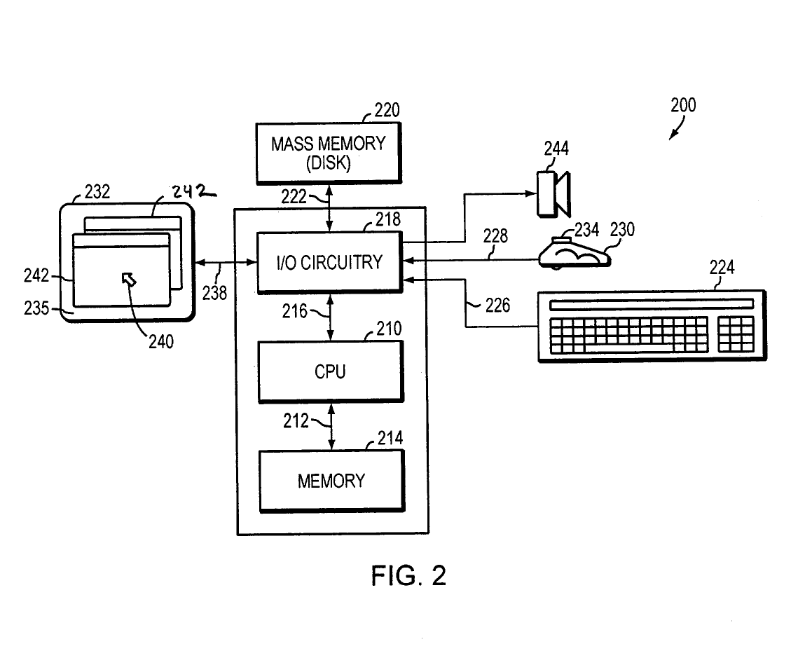

FIG. 2 illustrates a computer system 200 comprising a central processing unit (CPU) 210 coupled between a memory 214 and input/output (I/O) circuitry 218 by bi-directional buses 212 and 216, respectively. The memory 214 typically comprises random access memory (RAM) for the volatile storage of information, including application programs and an operating system, and read only memory (ROM) for persistent storage of the computer's configuration and basic operating commands. As further described herein, the application programs and the operating system interact to control the operations of the CPU 210 and the computer system 200.

The I/O circuitry 218 may be connected to a mass memory storage unit 220, such as a disk drive, via bi-directional bus 222. In the typical system 200, the memory storage unit 220 contains instructions that can be read by the CPU 210 in order to configure system 200 to provide the program-development features of the present invention. Cursor/pointer control and input devices, such as a keyboard 224 and a mouse 230, connect to the I/O circuitry 218 via cables 226 and 228, respectively. The mouse 230 typically contains at least one button or switch 234 that may be operated by a user of the computer system 200. A monitor 232 having a display screen 235 is also connected to the I/O circuitry 218 via cable 238. A pointer or cursor 240 may be displayed on the screen 235 and its position can be controlled via the mouse 230 or the keyboard 224, as is well-known in the art. As described further herein, a window environment is displayed on the display screen 235 of the monitor 232. The window environment includes one or more windows 242. A speaker system 244 may also be connected to I/O circuitry 218.

In general, the I/O circuitry 218 receives information, such as control and data signals, from the mouse 230 and the keyboard 224, and provides that information to the CPU 210 for storage on the mass storage unit 220 or for display on the screen 235. The I/O circuitry 218 preferably contains the necessary hardware, e.g., buffers and adapters, needed to interface with the mouse 230, the keyboard 224 and the display monitor 232.

A suitable computer system 200 for use with the present invention includes a personal computer, such as those manufactured and sold by International Business Machines Corp. of Armonk, N.Y., Compaq Computer Corp. of Houston, Tex. or Apple Computer, Inc. of Cupertino, Calif. The present invention may also be practiced in the context of other types of computers, including Unix-type workstations from Sun Microsystems, Inc. or Hewlett Packard. All of these computers have resident thereon, and are controlled and coordinated by, operating system software, such as Microsoft Windows® 95, 98 or NT, MAC OS or UNIX.

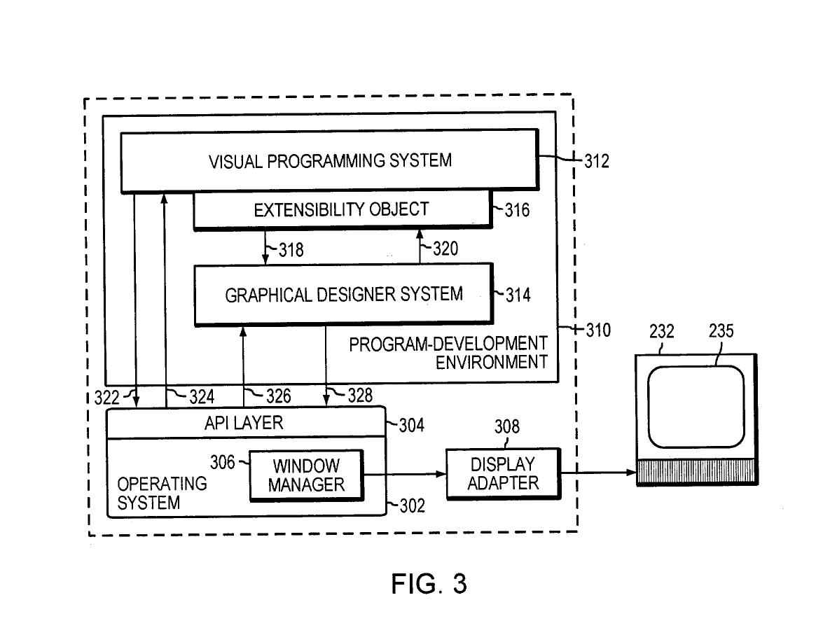

FIG. 3 is a highly schematic illustration of the software components of the computer system 200 of FIG. 2. These components include an operating system 302 having an application programming interface (API) layer 304 through which other application programs executing on computer system 200 may interact with the operating system 302. In particular, operating system 302 exchanges task commands to control the operations of the computer system 200 as well as notifications regarding various activity (e.g., windows events) with these other applications. The operating system 302 further includes system facilities, such as a window manager 306 which, inter alia, can directly implements those task commands and windows events. These system facilities are basically software routines within the operating system 302 that interoperate with lower layers of the operating system 302 and are responsible for managing various services and functions. The window manager 306, for example, may use a graphics system and a screen buffer to draw and manipulate windows on the display screen 235 of monitor 232. Under the control of various hardware and software in the computer system 200, the contents of the screen buffer may be read out and provided to a display adapter 308. The display adapter 308 contains hardware and software (sometimes in the form of firmware) which converts the information from the screen buffer to a form which can be used to drive the display screen 235 of monitor 232.

The lower-layers of the operating system 302 also include device drivers for interfacing directly with the computer hardware. For each physical device, such as the mass storage unit 220 (FIG. 2), a device driver is provided to accept requests, to read or write data or to determine the status of the devices. Communication between the physical devices and CPU 210 (FIG. 2) may be effected either through polling of the device drivers or via interrupts.

In accordance with the present invention, a program-development environment 310 is also executing on the computer system 200. The program-development environment 310 includes an extensible visual programming system 312 and a graphical designer system 314. The visual programming system 312, in turn, may include an extensibility object 316, which provides an interface for communication between the programming system 312 and the graphical designer system 314 as indicated by arrows 318 and 320. Arrow 320 represents calls from the designer system 314 to the programming system 312, while arrow 318 represents calls from the programming system 312 to the designer system 314. Additionally, both the graphical designer system 314 and the visual programming system 312 may communicate directly with the operating system 302, e.g., exchange task commands and windows events, via API layer 304, as indicated by arrows 322-328.

In the illustrative embodiment, the extensible visual programming system 312 is Visual Basic 5.0 or higher (preferably 6.0) or more preferably Visual Studio .NET from Microsoft Corp., and the graphical designer system 314 is configured as a Visual Basic or Visual Studio Add-In. Nonetheless, those skilled in the art will recognize that the present invention may also be advantageously used with other extensible visual programming systems, such as Visual C++, Visual J++, Visual Café, Visual InterDev, Delphi (for Pascal), etc. As described in more detail below, graphical designer system 314 allows the developer to switch the program-development environment 310 seamlessly between a graphical programming paradigm and a textual paradigm. The development environment 310 generates event handler procedures or program code for incorporation into the software program being developed, in response either to textual inputs or to graphical inputs from the developer.

To utilize the program-development environment 310, the developer first opens it in a conventional manner. For example, the development environment 310 may be represented by an icon on the user's desktop, which may be opened by “clicking” the icon using mouse button 234 (FIG. 2) in a conventional manner. Alternatively or in addition, the development environment 310 may be listed as one of the available programs within a Programs folder of a Start menu or by using a Run command. The development environment 310 may be configured, upon opening, to launch the corresponding visual programming system 312 and graphical designer system 314.

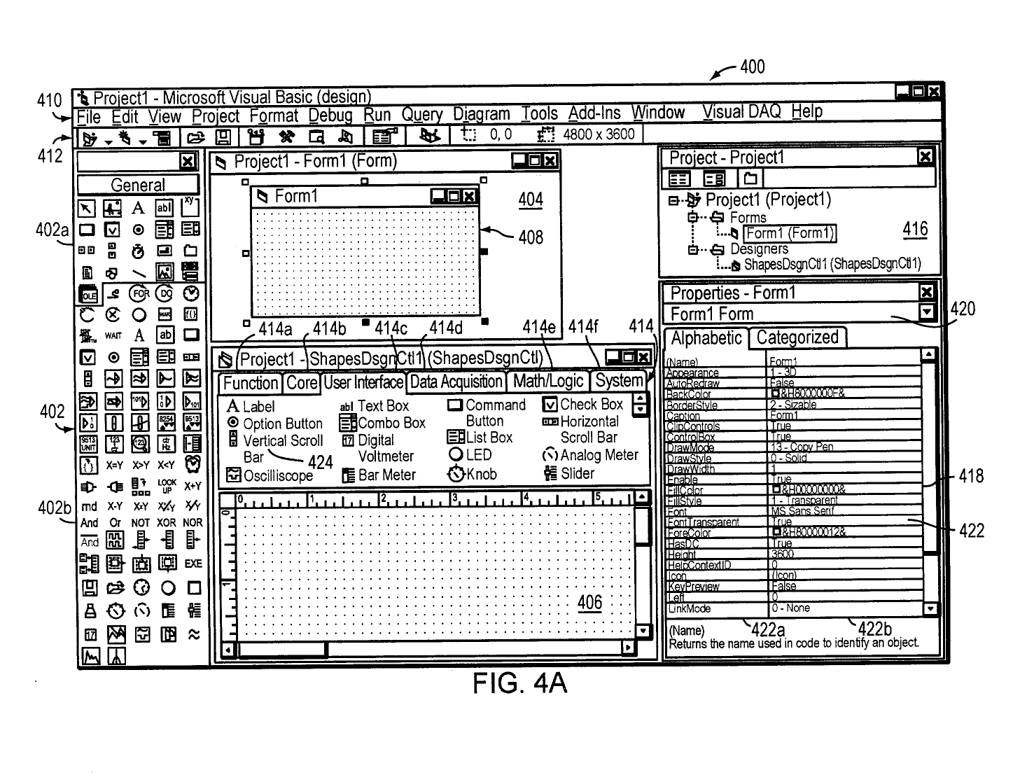

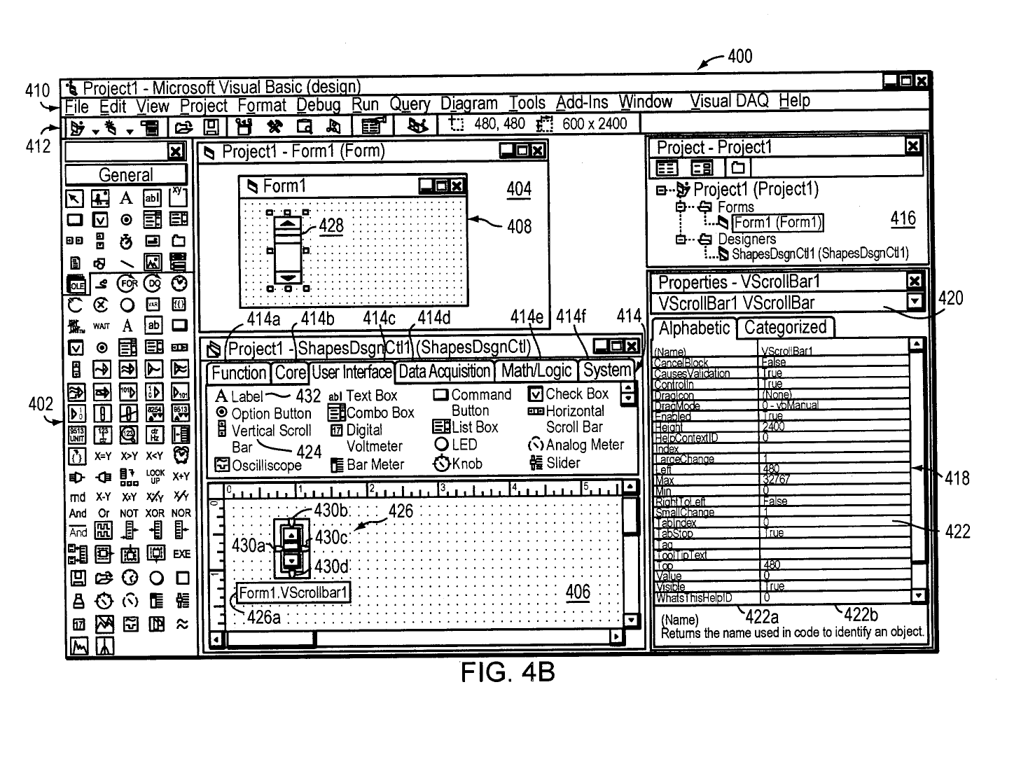

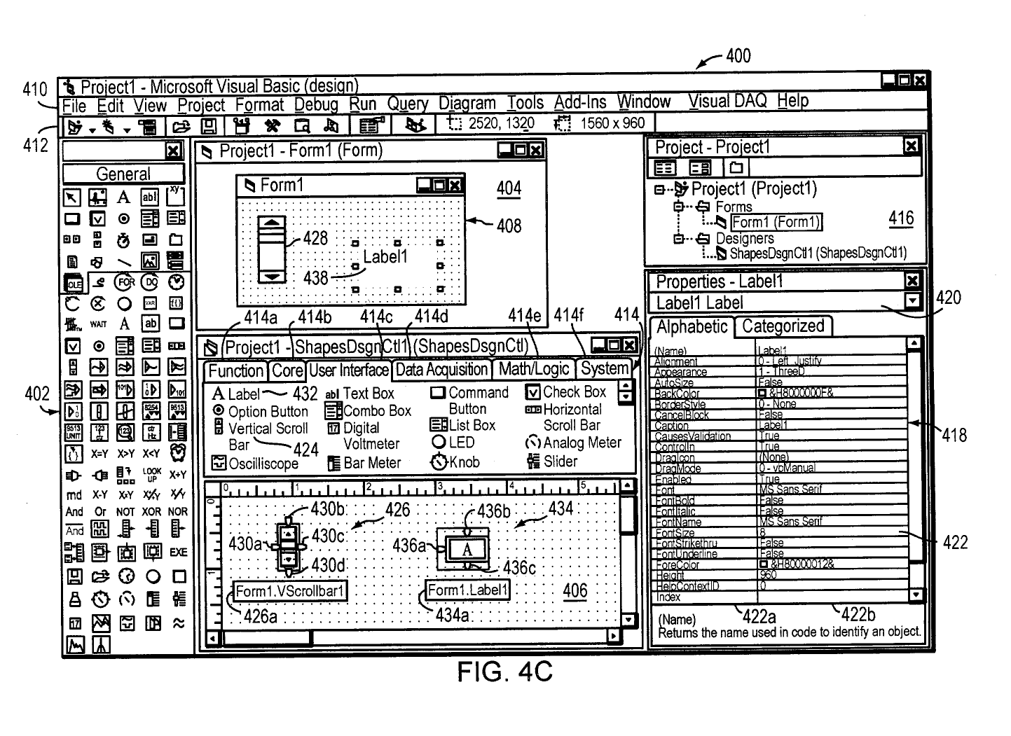

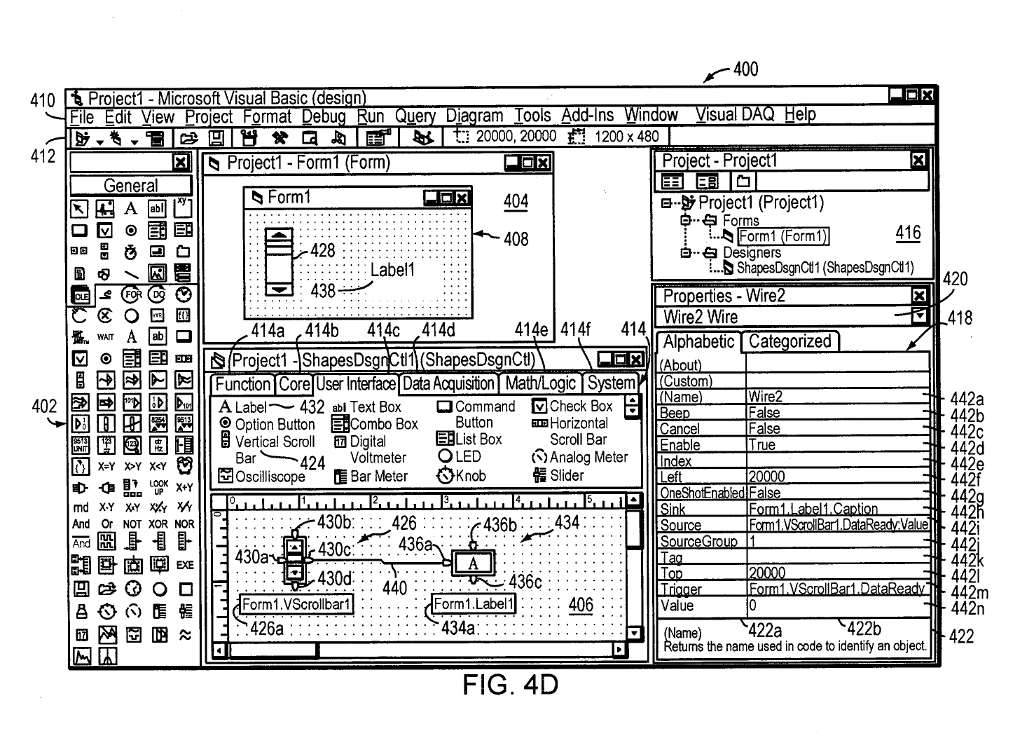

Upon opening, the graphical design system 314 cooperates with the visual programming system 312 to present a unified and coherent graphical user interface (GUI) to the developer on display screen 235 of monitor 232. FIG. 4A shows a preferred representation of this GUI 400. The GUI 400 has several elements, including at least one toolbox 402 that contains a plurality of icons. Each icon represents a corresponding component control or program object class that is available for use by the developer in creating application programs. The application programs that are ultimately created by the development environment 310 can be considered component-oriented, since they, among other things, call upon class factories that allocate memory for object members and ensure that the respective class methods have been loaded. The GUI 400 further includes one or more form windows 404 and a designer window 406. The form window 404 represents a container application that can “hold” instances of the control component or program object classes selected by the developer from the toolbox 402 for inclusion in the particular software program. By default, form window 404 includes a user form program object 408. The user form program object 408 basically provides an image of the user interface being developed for the application program. The GUI 400 may further include a menu bar 410 with a plurality of pull-down menu items and a toolbar 412 that contains a plurality of buttons providing short-cuts to commonly used tasks or functions.

As described below, the designer window 406 is configured to display a corresponding symbol for each program object added to the form window 404. These symbols, moreover, may be graphically linked together in order to create a data flow or block diagram that logically represents the flow of data and/or execution control of the application program that is being developed. The designer window 406 also includes its own toolbar 414, which may be divided into a plurality of sub-toolbars 414a-f, each having a corresponding tab that may be labeled (e.g., Function, Core, User Interface, Data Acquisition, Math/Logic and System). Disposed on each sub-toolbar 414a-f are one or more icons. Each icon represents a corresponding control component or program object class, the symbolic representation of which may be caused to appear in the designer window 406.

Each control component or program object instantiated from a corresponding class represented by an icon on toolbox 402 and/or toolbar 414 has pre-defined properties, methods and events. In addition, each program object typically performs some useful function, such as a Boolean operation (e.g., AND, OR, etc.), a mathematical operation, a data acquisition operation (typically from some transducer coupled to the I/O circuitry 218 of the computer 200), renders some comparison (e.g., less than, greater than, equal to, etc.), and so on. In the preferred embodiment, these control components or program objects are compatible with the ActiveX or Component Object Model (COM) technologies developed and made publicly available by Microsoft Corporation. The creation of ActiveX or COM objects is well-known to those skilled in the art and will not be described in detail here. For example, the creation of such objects is described in D. Appleman Developing COM/ActiveX Components with Visual Basic 6 (1999). The program objects and their classes may be stored in one or more dynamic link libraries (DLLs) within the memory 214 of the computer 200. The graphical designer system 314 and/or the visual programming system 312 preferably includes a link (e.g., a pointer) to these DLLs so that the available program object classes may be displayed as icons on the tool-box 402 and on the designer toolbar 414.

The program objects intended for use with the program-development environment 310 of the present invention are preferably pre-configured to have certain novel properties, methods and events. These additional properties, methods and events include the following:

PROGRAM OBJECT PROPERTIES

| Name | Data Type | Description |
|---|---|---|
| CancelBlock | Boolean | If set, prevents program object from execut- |
| | | ing or from completing execution of its |
| | | function. |
| ControlIn | Boolean | When used, controls when program object |
| | | begins execution of its function. |
| InvalidProperty | Integer | Invalidates an identified property of the pro- |
| | | gram object in order to ensure orderly |
| | | execution. |

PROGRAM OBJECT EVENTS

| Name | Description |
|---|---|
| RunBlock | Occurs when program object is about to commence |
| | executing its corresponding function. |
| InvalidateGroup | Occurs when program object is about to up-date one or |
| | more of its properties as a result of executing its cor- |
| | responding function. |
| DataReady | Occurs after program object has up-dated one or more |
| | of its properties as a result of executing its correspond- |
| | ing function. |
| RateReady | Issued by program objects that perform scanning |
| | operations upon successful completion of a scan. |
| StatusReady | For program objects that operate in one or more modes |
| | or states, this event occurs repeatedly while the pro- |
| | gram object executes its corresponding function. |
| ControlOut | Occurs when program object has completed execution. |
| ErrorOut | Occurs if program object generated an error during |
| | execution and may contain an identification of the type |
| | of error that was generated. It may also occur to |
| | indicate that no error condition was generated during |
| | execution. |

where Boolean means that the property may be set to True or False and Integer refers to any integer.

The GUI 400 may also include additional windows. For example, GUI 400 may include a project explorer window 416, which provides a hierarchical view of the current project. A project simply refers to the collection of files (e.g., form files, binary data files, class module files, etc.) and objects associated with the application program being developed. GUI 400 may also include a properties window 418 that displays the properties of a selected program object residing in the form window 404. The properties window 418 includes a pull-down object list 420, that contains a list of all of the program objects currently residing in the form window 404, and a property window 422, that is divided into two columns: a name column 422a and a current value column 422b. The name column 422a identifies all of the properties associated with the program object selected in the object list 420, while the current value column 422b shows the values that are currently associated with those properties.

To generate an application program, the developer selects one or more icons preferably from the designer toolbar 414 that perform requisite functionality for carrying out the tasks of the application program. In response, the program-development environment 310 places corresponding symbols in the designer window 406. The developer then graphically links these symbolic representations by drawing “wires” between them in order to create a data and/or execution control flow diagram. He or she will typically do this by using the mouse 230 (FIG. 2) or similar input device to cause the cursor 240 to move from one symbol to the next, although other graphical or even keyboard inputs may be used to perform the “graphical input”. In response, the graphical designer system 314 of the program-development environment 310 generates an event handler procedure to be run as part of the application program being developed. In accordance with the invention, the development environment 310 also includes in the same resultant application program other event handlers, which the developer optionally specifies textually by entering commands and other information in a code window that the development environment 310 also provides on GUI 400. That is, the development environment 310 gives the developer the option of using textual inputs in order to specify event handlers that might otherwise be impossible or more difficult to represent graphically.

Suppose, for example, that the developer wishes to create a simple software program in which the position of a vertical scroll bar is displayed in a label. From the User Interface designer sub-toolbar 414c, the developer first selects the vertical scroll bar icon 424. To select icon 424, the developer uses the mouse 230 (FIG. 2) to position the pointer 240 over the vertical scroll bar icon 424 and activates (e.g., “clicks”) the mouse button 234. This mouse click is a conventional windows event that is received by the operating system 302 (FIG. 3) in a conventional manner. Since the mouse click occurred over the designer window 406, operating system 302 passes this window event to the graphical designer system 314 of the program-development environment 310 by a communication mechanism represented by arrow 326, and the designer system 314 treats the windows event as a selection of the vertical scroll bar class by the developer.

As shown in FIG. 4B, in response to the selection of icon 424 from the User Interface designer toolbar 414c, the graphical designer system 314 causes a symbolic representation 426 of the program object corresponding to the vertical scroll bar class to be displayed in the designer window 406. The designer system 314 also issues a call to the visual programming system 312 through its extensibility object 316 as represented by the communication mechanism of arrow 320. This call directs the visual programming system 312 to instantiate a program object from the vertical scroll bar class and add that program object to the container application represented by the form window 404. That is, form window 404 may maintain a linked list of pointers to program objects that are considered to “belong” to the form, and in this list is placed a pointer to the vertical scroll bar program object that was instantiated. Since the vertical scroll bar is a user interface element, the visual programming system 312 also causes a vertical scroll bar image 428 to appear in the user form object 408. Vertical scroll bar image 428 basically corresponds to the way in which the vertical scroll bar user element will appear in the respective user interface at run-time of the application program being created. Vertical scroll bar image 428 may be moved and/or re-sized by the developer in a conventional manner.

As part of the process of adding a program object to the form window 404, the visual programming system 312 also assigns a name to that program object. The name may consist of the object's class followed by an integer, e.g., VScrollBar1 for the first vertical scroll bar added to form window 404. The name uniquely identifies the program object within the form 408. Upon adding the program object to the form window 404, the visual programming system 312 preferably returns the assigned name to designer system 314 by a communication mechanism represented by arrow 318. The program-development environment 310 may then display a name 426a as part of the symbolic representation 426 of the object in the designer window 406. The name displayed in designer window 406, e.g., Form1.VScrollBar1, may be derived by concatenating the name of the program object, e.g., VScrollBar1, with the name of the form window in which it resides, e.g., Form1.

As indicated, the symbolic representations appearing in designer window 406 are used by the developer to create a data and/or execution control flow diagram that logically corresponds to the application program being developed. To facilitate the generation of such diagrams and the creation of corresponding event handlers by the program-development environment 310, each symbolic representation in designer window 406 preferably includes one or more terminals disposed about it. These terminals, moreover, are associated with some pre-defined combination of the properties, methods and/or events of the respective program object that is symbolically represented. Vertical scroll bar 426, for example, has four terminals 430a-d. In order to facilitate a generally left to right data flow direction and a top to bottom execution control flow direction, the terminals of all symbolic representations appearing within the designer window 406 preferably conform to the following general rules. Terminals on the left side of a given symbolic representation, such as terminal 430a of vertical scroll bar 426, preferably correspond to a property used as an input by the respective program object. Terminals on the right side of a symbolic representation, such as terminal 430c of vertical scroll bar 426, preferably correspond to (i) an optional property generated as an output and (ii) an event of the respective program object. Terminals on the top of a symbolic representation, such as terminal 430b preferably correspond to a property which, when changed to a new value, triggers execution of the respective program object, and terminals on the bottom of a symbol, such as terminal 430d of vertical scroll bar 426 preferably correspond to an event that occurs when the respective program object has completed execution of its respective function.

The vertical scroll bar program object, for example, has a plurality of pre-defined properties, methods and events. In particular, the properties of the vertical scroll bar program object include: Enabled, Height, Width, Minimum, Maximum, Value, etc. The methods associated with the vertical scroll bar program object include Move, Drag, SetFocus, ShowHelp, Refresh, etc. The events associated with the vertical scroll bar program object include RunBlock, DataReady, ControlOut, etc.

Terminal 430a at symbol 426 is preferably associated with the vertical scroll bar's Value property. Terminal 430b is associated with the scroll bar's ControlIn property. Terminal 430c is associated with the vertical scroll's Value property and its DataReady event. Terminal 430d is associated with the object's ControlOut event.

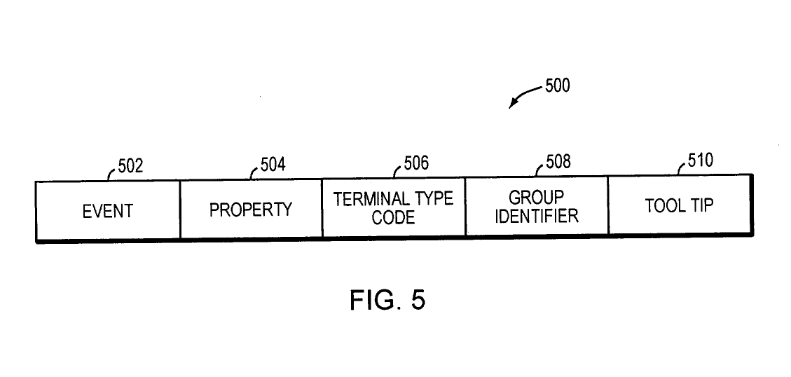

The association of properties and events to terminals is preferably maintained in a plurality of terminal data structures stored at memory 214 or 220. In particular, for each type or class of program object represented by an icon on the designer toolbar 414, there are one or more corresponding terminal data structures, depending on the number of terminals supported by the respective program object class. FIG. 5 is a highly schematic block diagram of a preferred terminal data structure 500. The terminal data structure 500 has at least four fields. A first field 502 preferably contains the name of the event, if any, that is associated with the particular terminal. A second field 504 preferably contains the name of the property, if any, that is associated with the particular terminal. If there is no event or property associated with the given terminal, then respective field 502 or 504 is set to null or de-asserted. A third field 506 preferably contains a code that identifies the particular type of terminal. In the illustrative embodiment, there are four types of terminals: data input, data output, control input and control output, and each type has a corresponding code. To the extent the data structure 500 corresponds to a data output type, a fourth field 508 is preferably used to store a group identifier. For a given type or program object class, the group identifier associates multiple data output type terminals whose corresponding properties are related to one another. For example, a joy stick object may have separate data output terminals for its “x” and “y” locations. Nevertheless, subsequent program objects should probably treat these two values as a single data point. Accordingly, the data output terminals associated with joy stick's “x” and “y” locations would preferably have the same group identifier. A fifth field 510 preferably contains a tool tip. A tool tip is a piece of descriptive text which is displayed to the developer when the cursor lingers over the respective terminal (e.g., “control input”, “error output”, and so on). The program-development environment 310 preferably maintains or otherwise has access to pointers to these various terminal data structures 500 within memory 214 (FIG. 2) (e.g., as a linked list). The pointers, moreover, may be mapped by the program-development environment to the names of the corresponding object classes so that, given the name of some object class, the program-development environment 310 can access the terminal data structures for each control or program object that has been instantiated from that class.

Symbolic representations appearing in the designer window 406, including the terminals, are preferably generated by the program-development environment 310 from respective bit maps stored in one or more image files within memory 214 (FIG. 2). The program-development environment 310 preferably maintains an association of bit maps to icons on the designer toolbar 414 so that when a developer selects a particular icon, the program-development environment 310 can direct the window manager 306 to draw the corresponding image from the appropriate bit map. Symbolic representations can also be moved about the designer window 406 by dragging them around with the mouse 230.

The developer then selects the next program object or control for use in the application program being created. Suppose that the developer selects the label icon 432 (FIG. 4B) from the User Interface sub-toolbar 414c. As shown in FIG. 4C, the program-development environment 310, in response, causes a symbolic representation 434 of a label program object to appear in designer window 406. Symbolic representation 434 also includes a plurality of terminals 436a-c, and may further include a name 434a. The program-development environment 310 additionally directs the visual programming system 304 to add a label program object to form window 404. Since the label program object is also a user interface element, like the vertical scroll bar, the visual programming system 304 additionally causes a label image 438 to be drawn on the user form object 408.

The label program object has its own pre-defined properties, methods and events. For example, the properties of the label program object include Height, Visible, Font, BackColor, Caption, ControlIn, CancelBlock, etc. Its events include RunBlock, ControlOut, etc. Data input terminal 436a of symbol 434, moreover, is preferably associated with the label's Caption property. Terminal 436b is associated with the ControlIn property, and terminal 436c is associated with the ControlOut event. Note that symbol 434 does not have any data output terminals.

Generation of Event-Handler Code Through Graphical Inputs

At this point, the developer has two program objects residing in the form window 404. With the prior art systems, such as the Visual Basic® programming system from Microsoft Corporation, the developer would now have to write one or more textual event handlers in order to have the position of the vertical scroll bar displayed in the label. As described above, the need to learn the keywords and syntax governing such textual event handlers has been a drawback to the use of Visual Basic by non-programmers, including scientists and engineers. With the program-development environment 310 of the present invention, the developer may cause the development environment 310 to generate corresponding handler procedure by simply graphically linking the symbolic representations of the program objects in the designer window 406 with one or more novel wire constructs. The developer need not generate any text-based code at all. Unlike the prior-art systems that only enable the user to graphically provide event handlers, though, the program-development environment 310 of the present invention also affords the developer the ability to provide or modify event handlers textually. It thereby frees the developer of the constraints and limitations imposed by such prior-art graphical programming tools.

To cause the position of the vertical scroll bar image 428 to be displayed in the label image 438 at application run-time, the developer graphically links the symbolic representation 426 of the vertical scroll bar program object to the symbolic representation 434 of the label program object using a wire construct, rather than writing a textual event handler. To connect symbols 426, 434 with a wire construct, the developer moves the cursor 240 (FIG. 2) to terminal 430c (FIG. 4C) at symbol 426 using the mouse 230. As described above, terminal 430c is associated with both the DataReady event and the Value property of the respective vertical scroll bar program object, i.e., VScrollBar1, which resides on the form window 404. With the cursor 240 over terminal 430c, the developer preferably executes a mouse click using mouse button 234. Since this mouse click occurred in the designer window 406, the operating system 302 (FIG. 3) passes the respective windows event to the designer system 314 by the communications mechanism represented by arrow 326. In response, the designer system 314 directs the operating system 302 to switch the mouse 230 from “cursor mode” to “line drawing mode” through a call via arrow 328. In particular, designer system 314 directs the operating system 302 to modify the appearance of the cursor 240 and to begin tracing subsequent mouse 230 movement with a line, whose first end is anchored to terminal 430c. Thus, as the developer drags the mouse 230 away from symbolic representation 426, a line emanates from terminal 430c following the movement of the mouse 230.

The developer preferably extends this line to terminal 436a of symbolic representation 434, which corresponds to label program object Label1 residing on form window 404. When the free end of this line reaches terminal 436a, the developer preferably executes a second mouse click. Again, the corresponding windows event is passed by the operating system 302 to the designer system 314 and it, in response, causes the free end of the line to become attached to terminal 436a. Designer system 314 also directs the operating system to stop tracing mouse movement with a line and to return the cursor 240 to its original appearance. FIG. 4D is an illustration of the GUI 400 with a wire construct 440 extending between the two symbolic representations 426, 434.

In response to graphically connecting or linking two symbols in the designer window 406, the program-development environment 310 creates event handler program code that sets the label object's Caption property to the value of the vertical scroll bar object's Value property when the vertical scroll bar object's DataReady event occurs. Clearly, there are several ways in which this can be accomplished. For example, Visual Basic code for handling the indicated event (e.g., DataReady) and affecting the designated property (e.g., Caption) could be generated and added to the application program, and that event handler program code could then be compiled or interpreted in the normal manner at run-time. Preferably, though, the program-development environment 310 instantiates a new control or program object, a wire program object, adds this new object to the form window 404 and sets its properties in a predetermined manner. The basic function of the wire program object is to retrieve the Value property from the vertical scroll bar object in response to the DataReady event and to set the Caption property of the label program object to that Value. That is, this new object basically provides event handler functionality for other program objects residing in the form window 404.

Specifically, the graphical designer system 314 directs the visual programming system 312 through calls to its extensibility object 316, as arrow 320 indicates, to instantiate a wire component control or program object from the wire object class and to add this object to the form window 404. That is, form window 404 adds a pointer to the wire program object to its linked list of controls. It should be understood that the wire construct 440 appearing in the designer window 406 is preferably just a symbolic representation of the wire program object added to the form window 404. The visual programming system 312 also assigns a name to this program object, e.g., Wire2, which it returns to the designer system 314. As described below, as part of its initialization procedure, designer system 314 preferably directs the visual programming system 312 to instantiate and add a wire program object, which may be named Wire1, to the form window 404. Thus, the “first” wire that is drawn on the designer window 406 by the developer actually corresponds to the second wire program object to be instantiated and added to the form window 404. Therefore, this wire program object is typically assigned the name Wire2.

The wire control or program object is itself a program module having its own predefined properties, methods and events. In the illustrative embodiment, each wire control or program object has the following properties, methods and events:

WIRE CONTROL PROPERTIES

| Name | Data Type | Description |
|---|---|---|
| Name | Text | Specifies the name of the wire program |
| | | object. |
| Beep | Boolean | Determines whether the wire program ob- |
| | | ject emits a “click” sound whenever it is |
| | | triggered. |
| Cancel | Boolean | Determines whether the wire program ob- |
| | | ject executes upon being triggered or |
| | | invoked. |
| Enabled | Boolean | Determines whether the wire program ob- |
| | | ject executes in response to its triggering |
| | | event. |
| Index | Text | Distinguishes between two or more wire |
| | | program objects having the same name. |
| Left | Integer | Specifies the x-coordinate position |
| | | of an image of the wire program object |
| | | appearing on the user form object. |
| OneShotEnabled | Boolean | If Enabled property is False, determines |
| | | whether the wire program object should |
| | | nonetheless execute one time. |
| Sink | Text | The name of the sink program object and |
| | | its respective property to which the wire |
| | | program object is graphically connected. |
| Source | Text | The name of the source program object |
| | | and its respective property to which the |
| | | wire program object is graphically |
| | | connected |
| SourceGroup | Integer | Used to organize related properties of the |
| | | source program object. |
| Tag | Text | Assigns an additional identifier to the wire |
| | | program object, typically for use by the |
| | | application program. |
| Top | Integer | Specifies the y-coordinate position of an |
| | | image of the wire program object appear- |
| | | ing on the user form object. |
| Trigger | Text | The name of the program object and its |
| | | respective event, the occurrence of which |
| | | causes the wire program object to execute. |
| Value | Variant | A data store, the contents of which can be |
| | | copied from the source, modified, if de- |
| | | sired, and passed to the sink by the wire |
| | | program object. |

WIRE CONTROL METHODS

| Name | Description |
|---|---|
| Run | Causes the wire program object to execute. |

WIRE CONTROL EVENTS

| Name | Description |
|---|---|
| Action(Value) | Occurs in response to the wire program being triggered |
| | or run. The argument corresponds to the current value of |
| | the wire's Value property prior to any event handling |
| | routines. |
| Done | Occurs once the wire program object has finished |
| | propagating its Action event and setting the specified |
| | sink property, provided that the Cancel property is still |
| | false. |

where Boolean means that the property may be set to True or False, Text means that the property is an alpha-numeric string, Integer means that the property is an integer, and Variant means that the property can take any of the data formats specified by the corresponding variant structure definition.

After the visual programming system 312 has added the wire program object to the form window 404 and returned its name, the designer system 314 next sets the various properties of this wire program object. The wire's properties, moreover, may be displayed in the property window 422 (FIG. 4D) of property window 418, as indicated by rows 442a-n, by selecting the wire program object, e.g., Wire2, from pull-down object list 420. The particular values to which the wire's properties are initially set depends on the particular program objects that have been logically connected by the wire construct 440 within designer window 406. For each wire control or program object, the designer system 314 identifies three corresponding program objects: a “source” program object, a “sink” program object and a “trigger” program object. Designer system 314 also examines the terminal data structures 500 that are associated with the graphically linked terminals 430c and 436a. Designer system 314 then uses this information to set the properties of the respective wire program object, i.e., Wire2.

It should be understood that attempts by the developer to wire a first input terminal to a second input terminal or a first output terminal to a second output terminal are rejected by the program-development system 310.

To identify the source, sink and trigger program objects, designer system 314 determines the names of the program objects that have been linked by the subject wire construct 440, the form window(s) on which those program objects reside, and the particular types of terminals that have been graphically linked by wire construct 440. As indicated above, information regarding the names of the graphically linked program objects and the form window(s) on which they reside is returned to the designer system 314 by the visual programming system 312 when system 304 adds those program objects to the form window 404. Thus, designer system 314 already has this information in its allocated portion of memory 214. Information regarding the types of terminals that have been linked is derived by the designer system 314 from the terminal type code fields 506 for the terminal type data structures 500 associated with the respective terminals, i.e., terminals 430c and 436a. The designer system 314 uses this terminal type information to determine which of the linked program objects should be considered the source object, which program object should be considered the sink object, and which program object should be considered the trigger object. In the preferred embodiment, the program object whose linked terminal is either a data output or control output type is treated as the source object, while the program object whose linked terminal is a data input or control input type is treated as the sink object. Here, linked terminal 430c at symbolic representation 426 is a data output terminal, while terminal 436a at symbolic representation 434 is a data input terminal. Thus, the designer system 314 considers the VScrollBar1 program object to be the source object and the Label1 program object to be the sink object for respective wire object, i.e., Wire2.

After identifying the source and sink control objects, the designer system 314 is ready to set the Sink, Source and Trigger properties 442h, 442i and 442m of Wire2. The wire program object's Source property is preferably a concatenation of the following information: the name of the form window 404 on which the source program object resides, e.g., Form1, the name of the source program object, e.g., VScrollBar1, and the property associated with the linked terminal at the source program object, e.g., Value. The Source property may further be concatenated with the event associated with the linked terminal at the source program object, e.g., DataReady. The designer system 314 preferably obtains the source event and property parameters for use in setting the wire's Source property from the event field 502 and property field 504 from the terminal data structure 500 associated with linked terminal at the source program object, i.e., terminal 430c. For data output type terminals, such as terminal 430c, system 314 similarly obtains the SourceGroup property parameter 442j from the group identifier field 805 from the corresponding terminal data structure 500.

The wire program object's Sink property 442h is preferably a concatenation of the following information: the name of the form window 404 on which the sink program object resides, e.g., Form1, the name of the sink program object, e.g., Label1, and the property associated with the linked terminal at the sink program object, e.g., Caption. Again, the designer system 314 preferably obtains the sink property parameter from the property field 504 of the terminal data structure 500 associated with linked terminal at the sink program object, i.e., terminal 436a. The wire program object's Trigger property 442m is preferably a concatenation of the following information: the name of the form window 404 on which the source program object resides, e.g., Form1, the name of the source program object, e.g., VScrollBar1, and the event associated with the linked terminal at the source program object, e.g., DataReady. As described above in connection with setting the Source property, this information may be derived from the name of the source program object and also from the contents of the event field 502 of the terminal data structure 500 associated with linked terminal at the source program object, i.e., terminal 430c. It should be understood that the designer system 314 may derive and set the Source property 442i first and then strip off the specified property of the source (e.g., Value), which was obtained from field 504 of the corresponding terminal data structure 500, to set the Trigger property 442m.

The wire program object preferably includes built-in functionality that automatically sets its Beep, Cancel and OneShotEnabled properties 442b, 442c and 442g to FALSE, and its Enabled property 442d to TRUE. The Value property 442n is preferably set, at least initially, to null or is otherwise de-asserted.

In the preferred embodiment, wire program objects are not intended to appear in any of the user interfaces that may be generated at run-time of the application program being developed. Accordingly, the Left and Top properties 442f, 442l of all wire program objects, which specify where on the user form object 408 an image of the object should appear (and, hence, where on the run-time user interface those images should appear), are set to default values (e.g., “20000”) that are sufficiently high so as to “place” the image of the wire program objects off of the user form object 408. Thus, at run-time, no image appears on the user interface corresponding to any wire program object that may nonetheless reside on the corresponding form window. Additionally, or alternatively, the wire object's Visible property may be set to FALSE.

Each wire program object instantiated and added to the form window 404 in response to graphical inputs of the developer includes at least some program code that may be called upon to execute when the respective application program is run. This program code, which is generated solely in response to the developer having graphically linked the symbolic representations of two program objects, basically causes the sink program object, e.g., Label1, to execute or otherwise take some action in response to an event generated by a trigger program object, e.g., VScrollBar1, and using some property of the source control object. That is, the wire object represents event handler procedures or code incorporated within the application program.

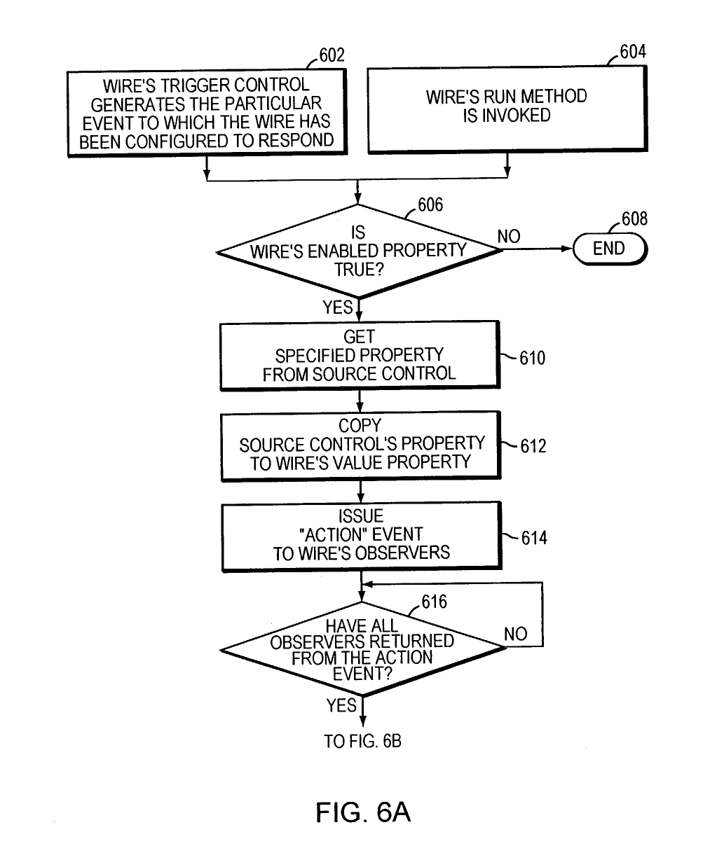

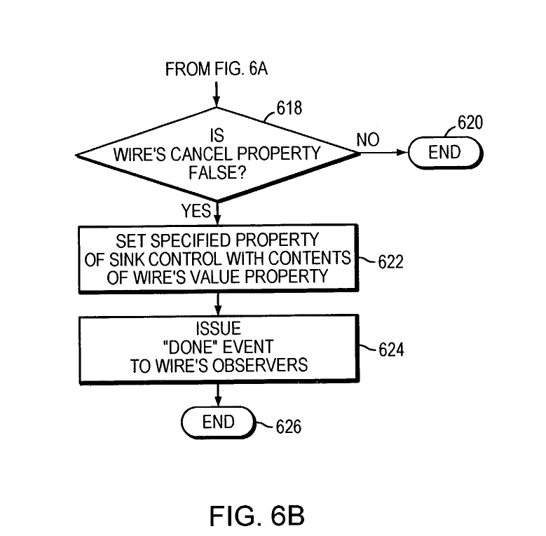

FIGS. 6A and 6B are a flow diagram of the steps corresponding to the preferred event handler procedure or code generated by the program-development environment 310 in response to such graphical inputs from the developer. This procedure may be called upon to execute during run-time of the application program. Running of the graphically generated event handler procedure may be initiated in one of two ways. First, it is initiated when the trigger control component, as identified in the wire's Trigger property 442m, e.g., VScrollBar1, issues the particular event also identified in the wire's Trigger property 442m, e.g., DataReady, as indicated by block 602. In order to learn of the occurrence of this event (e.g., DataReady), the wire program object preferably registers with the trigger program object using an Event_Advise_Notification( ) method having the desired event as an argument. In response, the VScrollBar1 object notifies Wire2 whenever its DataReady event occurs. Alternatively, the event handler procedure may be initiated by invoking the wire's Run method, as indicated by block 604. Following initialization, the next step is to determine whether the wire program object's Enabled property 442d is TRUE, as indicated at block 606. If the wire's Enabled property 442d is FALSE, the code preferably ends, as indicated by first end block 608. As explained above, when the wire program object is first instantiated, it sets its Enabled property 442d to TRUE. Thus, unless the Enabled property 442d was subsequently set to FALSE at some point during run-time, as explained below, or was re-set by the developer, the response to decision block 606 is typically yes.

As indicated at block 610, the event handler procedure next retrieves the value of the property specified in the wire's Source property 442i, e.g., Value, from the source object, e.g., VscrollBar1, also identified in the wire's Source property 442i. To do this, a Get( ) method may be invoked on the source program object. A separate Get( ) method may be invoked for each readable property. The Get( ) method is a conventional method that is preferably supported by all of the component controls or program objects utilized by the program-development environment 310 of the present invention. As an argument to the Get( ) method, the code inserts the name of the property, e.g., Value, the value or setting of which is to be returned. Suppose the current setting of the VScrollBar1's Value property is “15”. Then, in response to the Get( ) method, the VScrollBar1 returns “15” to the wire program object. This value may be returned to the wire program object through either a Pass_By_Value or Pass_By_Reference communication method, both of which are well-known to those skilled in the art. The wire program object next copies this value, i.e., “15” to its own Value property 422n, as indicated at block 612. Upon copying the value into its Value property, the wire program object preferably issues its Action event, as indicated at block 614. Other elements or processes of the application program, including other component controls or program objects, may register as “observers” with the wire program object using the Event_Advise_Notification method described above so as to be notified of the wire's Action event. These observers may respond to the wire's Action event in any number of ways. At decision block 616, the wire program object waits until all of these “observers” have indicated that they have finished processing the wire's Action event.

Next, the wire program object queries whether its Cancel property 442c (FIG. 4D) is FALSE, as indicated at block 618. As explained above, when the designer system 314 first sets the properties of a wire program object, it sets the Cancel property 442c to FALSE. In response to the wire's Action event (or some other event), however, another process, control component or program object may change the wire's Cancel property 442c from FALSE to TRUE. If the wire's Cancel property 442c is TRUE, then execution stops as indicated by second end block 620. Assuming the wire's Cancel property 442c is still FALSE, then the wire next up-dates the Sink property 442h, i.e., Caption, with the current value of its own Value property 442n, as indicated at block 622. This may be accomplished by invoking a Set( ) method on the sink control identified by the wire's Sink property 442h, i.e., Label1. A separate Set( ) method may also be invoked for each settable property. The Set( ) method is another conventional method supported by all of the component controls or program objects utilized in the program-development environment 310 of the present invention.

After setting the sink's property, the code corresponding to the wire program object issues a Done event, as indicated at block 624. Observers may similarly register with the wire program object, again using the above-described Event_Advise_Notification method, so as to be notified of its Done event. These observers may be configured to take any number of different actions in response to the wire's Done event. At this point, the wire program object has finished executing as indicated by third end block 626.

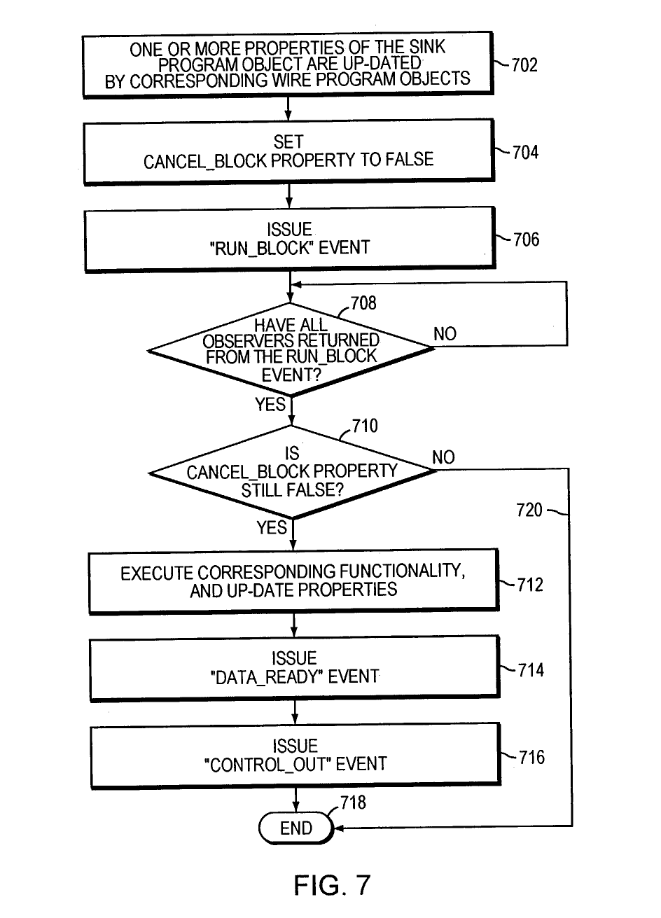

FIG. 7 is a flow diagram of steps preferably executed by a typical program object, such as the Label1 program object, incorporated in the application program being developed during application run-time. The program object begins execution in response to one or more of its properties being up-dated by a corresponding wire object as indicated at block 702, such as when the Wire2 object up-dates the Caption property of Label1. Next, the program object sets its CancelBlock property to FALSE as indicated at block 704. The program object then issues its RunBlock event as reflected at block 706. As with the Action and Done events issued by the wire program objects, observers (including wire program objects) may register with the program object using the Event_Advise_Notification mechanism so as to be notified of its RunBlock event. These observers may interact with the program object by, for example, changing its properties etc. As indicated by decision block 708, the program object waits until all such observers have returned from its RunBlock event.

Next, the program object determines whether its CancelBlock property is still FALSE as indicated at decision block 710. One or more of the observers could have set the program object's CancelBlock property to TRUE in response to processing the RunBlock event. If its CancelBlock property is still FALSE, the program object executes its corresponding functionality and up-dates its own corresponding properties as warranted as indicated by block 712. Upon up-dating its properties, the program object issues its DataReady event as indicated by block 714. To the extent a wire program object is connected to one of this program object's data output terminals, the issuance or occurrence of the DataReady event may trigger that wire program object to begin operation. After issuing its DataReady event, the program object next issues its ControlOut event as indicated by block 716. To the extent the program object's control output terminal is connected to a wire construct, the corresponding wire may begin operation. Execution of the program object is now complete as reflected by End block 718. If, in response to decision block 710, the program object's CancelBlock property is TRUE, then processing stops at that point as indicated by No arrow 720 leading from decision block 710 to End block 718.

It should be understood that a given program object may execute its corresponding functionality, as described at step 712, and then issue a RunBlock event, as described at step 706. This may be implemented by objects that perform mathematical operations, for example, and are thus less likely to cause erroneous data propagation problems in the corresponding application program. It should be further understood that, depending on the type of program object, other events besides DataReady may be issued. For example, program objects that operate in discrete or determinative modes or states, such as the For Loop, Do Loop and Wait objects, described below, or an Analog In Scan object, may issue one or more StatusReady events in place of the DataReady event. Program objects that perform scanning functions, such as Analog In Scan or Analog Out Scan, may issue a RateReady event in place of the DataReady event. Those skilled in the art, moreover, will recognize that other such events may be defined and implemented by the program objects utilized with the program-development environment 310.

Generation of Event-Handler Code Through Textual Inputs

A significant advantage of the present invention is its ability also to generate event handler procedures or code in response to textual inputs by the developer. In some circumstances, for example, it may be more efficient to specify an event handler textually rather than graphically. In particular, following the example of FIGS. 4A-D, suppose the developer wishes to have the background color of the label image 438 turn red during run-time whenever the value to be displayed exceeds 15000. Although the label object has a BackColor property, in the absence of a specific terminal on the corresponding symbolic representation 434 for the Label1 program object that is associated with this property, it would be difficult to specify this functionality graphically. Indeed, with the prior art graphical program languages, such as HP VEE and LabVIEW, it would be extremely difficult, if not impossible, to provide this functionality, because the graphical images for the label program object provided by these prior art systems do not have a terminal or pin for setting the object's background color in response to the value of its Caption property.

With the present invention, the program-development environment 310 allows the developer to switch to a textual programming paradigm in order to specify an event procedure or other functionality that is more easily described textually as opposed to graphically. To specify an event handler textually, the developer directs the program-development environment 310 to call-up and display a code window in which textual inputs may be entered by the developer. More specifically, the developer, using mouse 230, moves the cursor 240 (FIG. 2) over the symbol of interest, e.g., Label symbol 438 (FIG. 4D), as displayed in the designer window 406 and executes a double mouse click. Since the cursor 240 is over the designer window at the time of the mouse click, the operating system 302 (FIG. 3) preferably passes the respective windows event to the graphical designer system 314. In response, the designer system 314 issues a call to the visual programming system 312, via arrow 320, causing it to display a code window on GUI 400 (FIG. 4D).

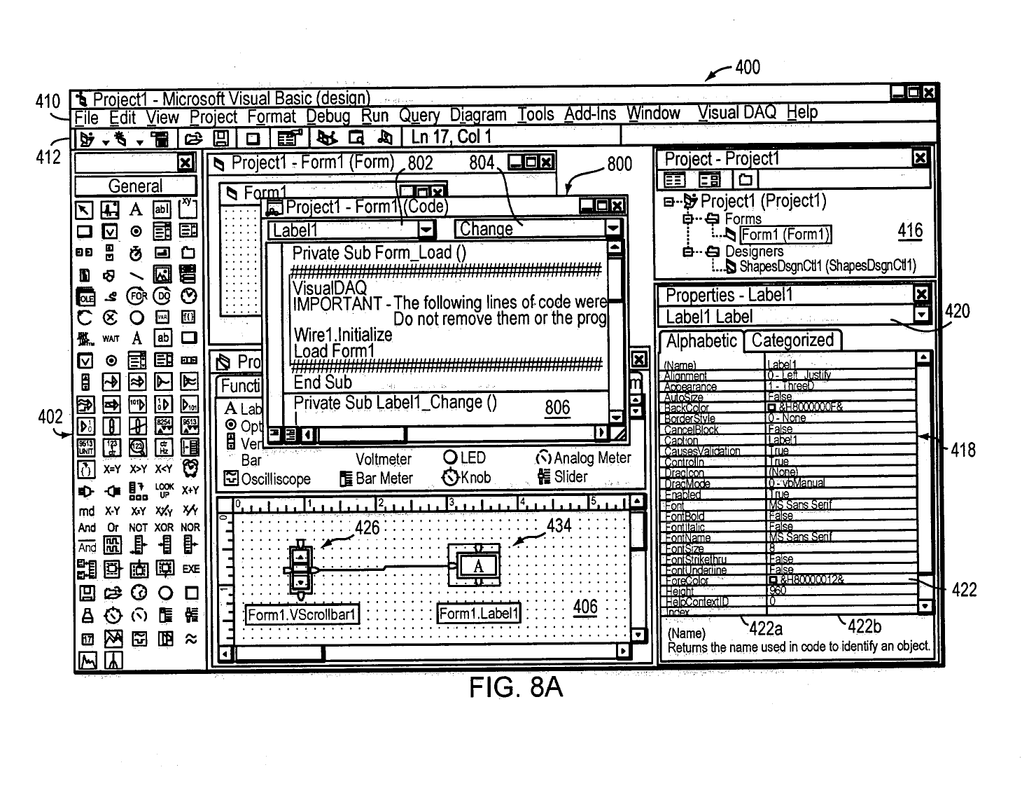

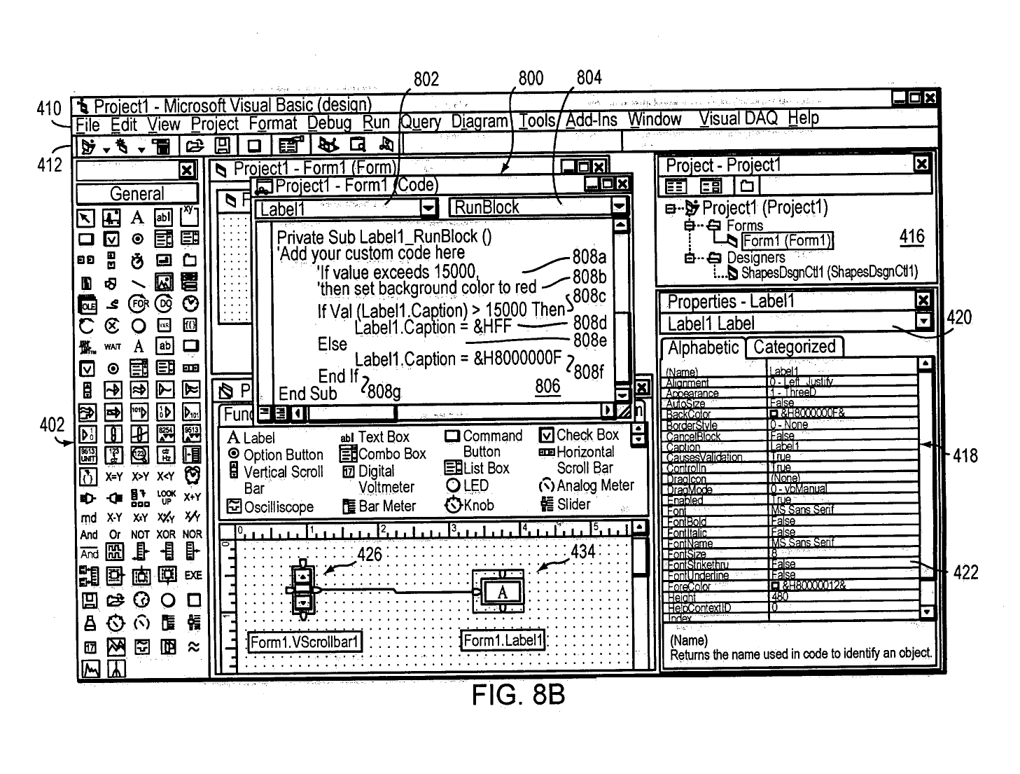

FIG. 8A is a preferred illustration of the GUI 400 of FIG. 4D further including a code window 800. Code window 800 includes a pull-down object box 802, which contains a list of all of the program objects currently residing in the form window 404. By default, the object box 802 initially displays the program object selected by the developer, e.g., Label1. Code window 800 further includes a pull-down procedures/events box 804, which contains a list of all of the procedures and events supported by the selected program object of object box 802. Selecting a particular procedure or event from box 804 positions the entry point for subsequent textual inputs at the first line of the respective procedure or event. The procedures/events box 804 may initially display the first event supported by the corresponding object, e.g., the Change event, which is issued when an object's Value property changes. Code window 800 further includes an input area 806. Within the input area 806, the developer can write, review and edit program code for the respective application program using the keyboard 224 to generate textual inputs. In the preferred embodiment, the developer enters one or more statements within input area 806. A statement is basically a syntactically complete unit that expresses some action, declaration or definition. A statement generally occupies a single line, although a first designated symbol, e.g., the colon (“:”), may be used to include more than one statement on a line, and a second designated symbol, e.g., the line-continuation character (“_”), may be used to continue a single logical line onto a second physical line.

FIG. 8B is a preferred representation of the GUI 400 after the developer has written a series of statements 808a-g into the input area 806 of the code window 800 following the selection of the RunBlock event from the procedures/events box 804. As indicated above, statements 808a-g comply with the keywords and syntax defined by the programming language supported by the visual programming system 312 of the program-development environment. In the illustrative embodiment, this programming language is Microsoft's Visual Basic. Statements 808c-g specify the functionality for turning the background color of the label image 438 red if its Caption property (which is set to the Value property of VScrollBar1) exceeds 15000. Statements 808a-b are simply comment statements that describe the functionality to be carried out by the subsequent statements.

In response to entering one or more statements in the input area 806 of code window 800, the program-development environment 310 generates constituent program code for insertion in the corresponding application program. That is, at run-time, the statements 808a-g are compiled or interpreted and executed as required, thereby implementing the functionality of the corresponding statements.

Those skilled in the art will understand that the code window 800 may be called-up in other ways. For example, the developer may choose the “Code” option (not shown) from the View command of menu bar 410.

It should be understood that a developer may also display and edit the properties of a wire program object, thereby causing the program-development environment 310 to modify the corresponding event handler procedure. As described above, the developer may cause the properties of a wire object, e.g., Wire2, to be displayed in the properties window 418 of GUI 400. By selecting one of the properties listed in the property window 422 of window 418, typically through a mouse click, the developer can edit the selected property. For example, although the wire program object preferably sets its Beep property 442b to FALSE upon instantiation, the developer may re-set this property to TRUE through textual inputs entered in the property window 418. In response, the event-handler procedure generated by the program-development environment 310 causes the computer system 200 to sound a tone each time the wire program object executes.

The developer may also change a given wire object's trigger property 442m to a different event and/or a different program object. More specifically, as described above, the program-development environment 310 sets the trigger property 442m of a wire program object based on the particular source terminal, e.g., terminal 430c, to which the wire construct 440 of the corresponding wire program object, e.g., Wire2, is connected. The wire program object, moreover, executes in response to the occurrence of the event specified in its trigger property 442m. By editing the trigger property 442m, a developer may cause the program-development environment 310 to modify the corresponding event handler procedure such that the wire program object now executes in response to some newly identified event and/or program object (e.g., an object other than the wire's source object). To prevent developer-induced errors, the program-development environment 310 may be configured to block the display (and thus the editing) of wire program object properties through property window 418.

Although the program development environment 310 of the present invention involves graphical event handler code generation, some implementations may not provide that capability for all available control components or program objects that may be incorporated into a given application program. Or, they may provide different toolbox icons or elements for the same control components, some of which enable the developer to program the control's event handlers graphically and others that do not. In such implementations, the toolbox 402 (FIG. 4A) may be divided into two areas. A first area 402a contains a plurality of icons corresponding to program object classes that can only be used in the form window 404. The program objects corresponding to these icons do not have a corresponding symbolic representation for use in the designer window 406. A second area 402b contains a plurality of icons that can be used in both the form window 404 and the designer window 406. That is, the program objects corresponding to these icons include symbolic representations capable of display in the designer window 406.

It should be understood that program objects need not include all of the above-specified properties or events. For example, program objects may not have an InvalidProperty property or a StatusReady event. Furthermore, rather than a single RunBlock event, program objects may have a PreRunBlock event, which occurs when the program object has latched its input properties and is ready to perform its primary function, and a PostRunBlock event, which occurs after the program object has executed its primary function and is ready to update its output property(ies). In addition, various of the properties, methods and events may be given different names.

The wire controls may also be defined without all of the above-identified properties, methods or events. For example, the wire controls may be without index, left, right or tag properties. Furthermore, rather than including the property of the sink object in the wire control's Sink property, a new property, known as the SinkProperty, may be provided, which corresponds to the name of the sink program object's respective property to which the wire control is graphically connected. Similarly, rather than include the source property as part of the wire control's Source property, a new property, known as the SourceProperty, may be provided, which corresponds to the name of the source program object's respective property to which the wire control is graphically connected. Those skilled in the art will recognize that other changes may also be made.

Masked Edit Control

According to the present invention, the program-development environment 310 (FIG. 3) is further configured to incorporate program code within the application program being developed that facilitates data entry by a user of the application program during run-time. In particular, as described below, the program-development environment 310 includes a masked edit control or program object that can be instantiated one or more times and placed onto a program development form. The masked edit program object may be represented by a corresponding icon that may be caused to appear in the designer window 406 of the GUI 400. Each masked edit icon within the designer window 406 also has a masked edit user interface element in the user form program object window 408. The icon representing the masked edit program object may be connected to other icons within the designer window 406 using one or more wire constructs in order construct a desired application program.

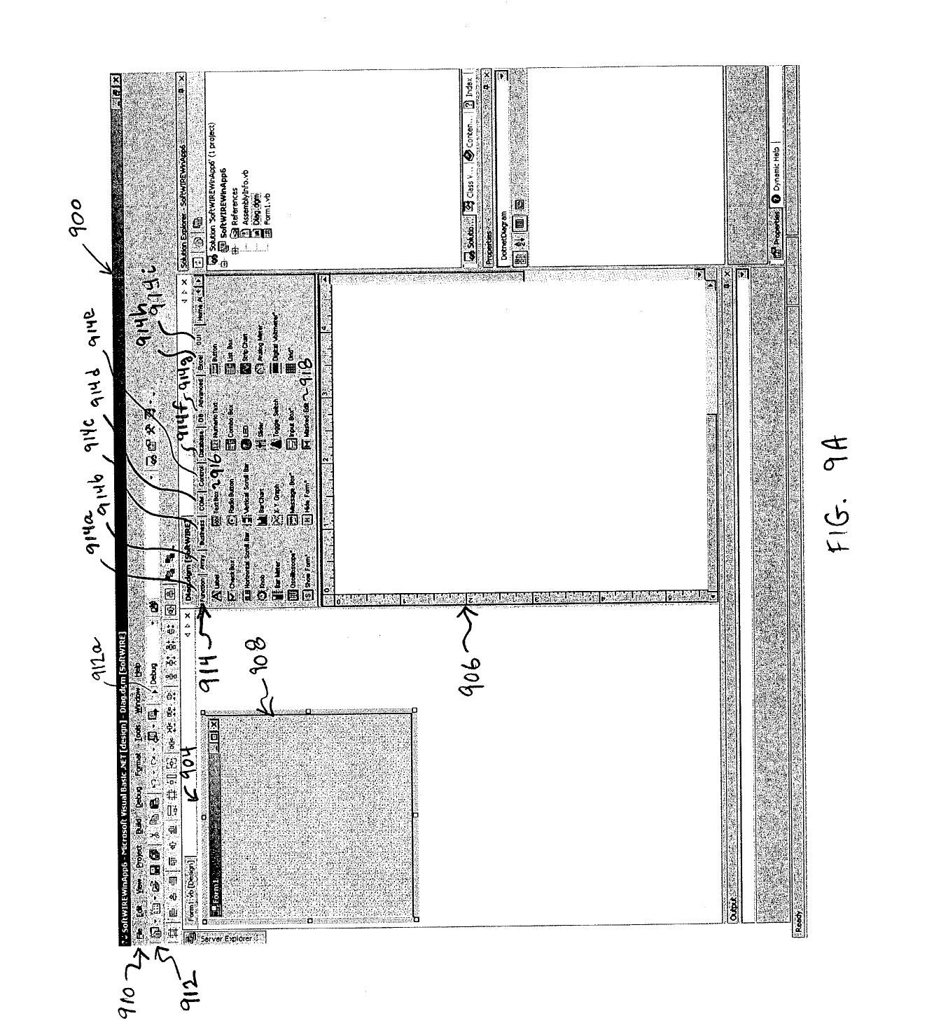

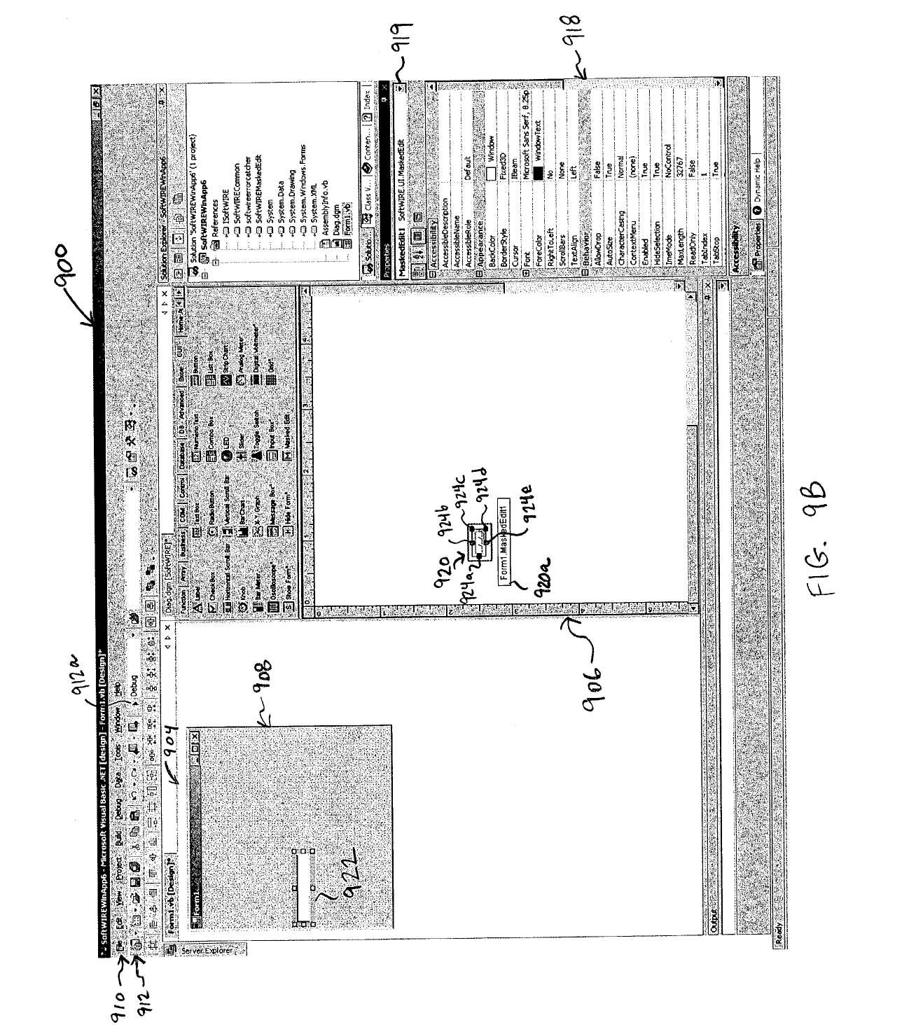

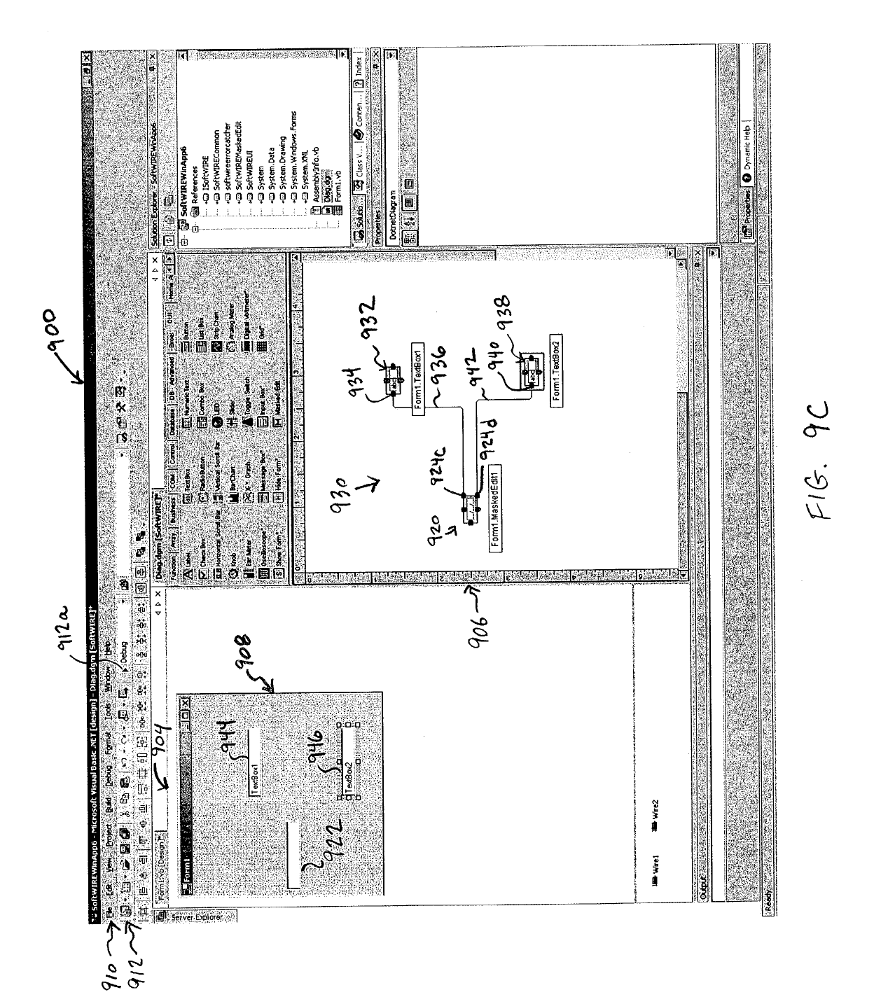

The use and operation of the masked edit control-may best be understood through an example. FIGS. 9A-E are preferred representations of a program development GUI that has been manipulated to include a flow diagram that incorporates a masked edit control icon. FIGS. 9A-E are preferred representations of a GUI 900 generated by the program-development environment 310 (FIG. 3) on computer screen 235 similar to GUI 400 (FIG. 4A) described above. Like GUI 400, GUI 900 also has several elements including one or more form windows 904 and a diagrammer or designer window 906. The form window 904 includes a user form program object 908, which provides an image of the user interface being developed for the application program. The GUI 900 may further include a menu bar 910 with a plurality of pull-down menu items and a toolbar 912 that contains a plurality of buttons providing short-cuts to commonly used tasks or functions, including a play or run button 912a. The designer window 906 also includes its own toolbar 914, which may be divided into a plurality of sub-toolbars 914a-i, each having a corresponding tab that may be labeled (e.g., Function, Array, Business, COM, Control, Database, Database (DB)—Advanced, Excel, and GUI). Disposed on each sub-toolbar 914a-i are one or more pictorial representations. Each pictorial representation corresponds to a control or program object class, and selection of a pictorial representation (e.g., through a mouse click) causes an instantiation of the control or program object to placed in a form and further causes an icon to appear in at least the designer window 906. Included on the GUI sub-toolbar 914i are a Text Box pictorial representation 916 and a Masked Edit pictorial representation 918, among others.

With reference to FIG. 9B, in response to the program developer's selecting pictorial representation 918 from the GUI sub-toolbar 914, the graphical designer system 314 causes an icon 920 of the program object corresponding to the Masked Edit class to be displayed in the diagrammer window 906. The designer system 314 also issues a call to the visual programming system 312 directing the visual programming system 312 to instantiate a program object from the Masked Edit class and add that program object to the container application represented by the form window 904. As the Masked Edit control is a user interface element, the visual programming system 312 also causes a masked edit user interface symbol 922 to appear in the user form object 908. Masked edit symbol 922 basically corresponds to the way in which the masked edit user element will appear in the respective user interface at run-time of the application program being created. Masked edit symbol 922 may be moved and/or re-sized by the developer in a conventional manner.

As part of the process of adding a program object to the form window 904, the visual programming system 312 also assigns a name to that program object. The name may consist of the object's class followed by an integer, e.g., MaskedEdit1 for the first masked edit control to be added to form window 904. The name uniquely identifies the program object within the form 904. Upon adding the program object to the form window 904, the visual programming system 312 preferably returns the assigned name to designer system 314 by a communication mechanism represented by arrow 318. The program-development environment 310 may then display a name 920a as part of the icon within the diagrammer window 906. The name displayed in diagrammer window 906, e.g., Form1.MaskedEdit1, may be derived by concatenating the name of the program object, e.g., MaskedEdit1, with the name of the form window in which it resides, e.g., Form1.

The Masked Edit program object of the present invention preferably has a plurality of predefined properties, methods and events many of which are public and may thus be set or accessed by the program developer. In particular, the properties of the Masked Edit program object include: AcceptedText, AllowLiteralEntry, BeepOnError, InputText, InsertZeros, Mask, MaskedText, OutputOnLostFocus, PromptChar, PromptInclude, SelectAllOnFocus, TabOnEnter, and ControlIn. The method associated with the Masked Edit program object is Operate. The events associated with the Masked Edit program object include: RunBlock, DataReady, ControlIn, ControlOut, etc.

The Masked Edit icon 920 preferably has a plurality, e.g., five, pins or terminals 924a-e, each of which is associated with a pre-defined combination of the properties, methods and/or events of the respective Masked Edit program object that is symbolically represented by icon 920. Specifically, terminal 924a is associated with the Masked Edit's Input Text property. Terminal 924b is associated with the Masked Edit's ControlIn property. Terminal 924c is associated with the masked edit's MaskedText property and its DataReady event. Terminal 924d is associated with the masked edit's AcceptedText property and its DataReady event. Terminal 924e is associated with the masked edit's ControlOut event.

The properties (or at least those properties that are declared public and may thus be changed by the program developer) of the Masked Edit program object may each be selectively displayed by the program-development environment 310 (FIG. 3) in a properties window 918 by selecting the desired object from a pull-down object list 919. The specific properties displayed within the corresponding properties window 422, moreover, may be modified and edited by the developer, thereby changing the properties of the respective object residing in the form window 904.

FIG. 9C shows a data/control flow diagram 930 that was created within the diagrammer window 906 by a program developer. Diagram 930 includes, in addition to the masked edit icon 920, a first TextBox icon 932 whose input terminal 934 is coupled via a first wire construct 936 to output terminal 924c of the masked edit icon 920. Diagram 930 further includes a second TextBox icon 938 whose input terminal 940 is coupled via a second wire construct 942 to output terminal 924d of the masked edit icon 920. As the two TextBox icons 932 and 938 that were added to the diagrammer window 906 are user interface elements, companion symbolic representations 944 and 946 are displayed in the form window 904.

To edit a program object's properties, such as the masked edit program object represented by icon 920, the program developer may display the selected program object's properties in the properties window 918 as described above. The program-development environment 310 also supports at least one or more additional ways of editing a program object's properties. In particular, as shown in FIG. 9D, when the developer executes a “right mouse click” on a selected icon, such as the masked edit icon 920, the program-development environment 310 causes a command pop-up menu 950 to appear. Command window 950 displays a series of commands that may be performed on the program object of the selected icon, e.g., on the masked edit program object corresponding to icon 920. One of these commands is a Properties command 952.

As shown in FIG. 9E, by selecting (e.g., clicking) the properties command 952 (FIG. 9D), the program developer causes the program development environment 310 to display a properties page dialog window 954 on for the masked edit program object corresponding to icon 920. This properties page dialog window 954 includes a plurality of entry fields and check boxes. Specifically, window 954 includes a Mask Property field 956 and a corresponding list box 958 containing a plurality of predefined input masks that may be selected by the program developer, and modified as desired. Window 954 further includes a maximum (max) length field 960 that can be set to specify the upper limit of input data that is to be received by the input mask being defined, e.g., the maximum number of characters that the masked edit program object of icon 920 will accept by the program user during run-time. A prompt character field 962 can be used to specify the character, e.g., the underscore symbol “_”, that will be displayed during run-time to indicate to the program user where user input is expected in the input mask. An input text field 964 can be loaded with a message that will be displayed within the masked edit symbol when the program is first run.

As mentioned above, window 954 also includes a plurality of check boxes that may be set, i.e., checked or unchecked, by the program developer. In particular, a first check box 966 labeled “Include prompt characters in output” will, if checked by the program developer, cause the specified prompt characters, e.g., the underscore, to be output in any empty entries as part of the data output by the masked edit control 920 during run-time. A second check box 968 labeled “Beep on error” will, if checked, cause a sound to be played in response to every invalid or improper keystroke. A third check box 970 labeled “Insert Zeros in output for empty entries” will, if checked, set the masked edit program object's InsertZeros property to true, thereby causing zeros, e.g., 0, to be inserted into empty optional-numeric characters, thereby adjusting for leading and trailing zeros. A fourth check box 972 labeled “Allow entry of literal characters (date/time separators, decimal points, thousands separator)” will, if checked, set the masked edit program object's AllowLiteralEntry property to true. A fifth check box 974 labeled “Select all on focus” will, if checked, cause the complete contents of the masked edit to be highlighted when it gets in focus. In Windows terminology, a window or user input element that has “focus” is the window or user input element that receives keyboard input. A sixth check box 976 labeled “Output on lost focus” will, if checked, cause the masked edit control to output its value when it loses focus. A seventh check box 978 labeled “Tab on enter” will, if checked, make pressing the Enter key by the program user perform the same operation as pressing the Tab key when the masked edit has focus. During run-time, when a control has focus on a form, pressing the Tab key switches focus to the next control in the form's tab order.

The following table specifies the input masks and their default settings that are contained in the list box 958 of window 954 only some of which are illustrated in FIG. 9E. The program developer may select any of the listed input masks or create a custom input mask.

TABLE 1

| Name | Mask Value | Description |
|---|---|---|
| None | Empty String | Default. No mask. Results in |
| | | the masked edit control opera- |
| | | ting like a standard Text Box |
| | | control |
| Date | ##/##/#### | Date mask, e.g., 05/20/1992 |
| Medium Time | ##:##?? | Medium time mask, e.g., |
| | | 05:36 AM |
| Short Time | ##:## | Short time mask, e.g., 17:23 |
| Short Phone | (###) ###-#### | Short telephone number mask, |
| Number | | e.g., (508) 946-8900 |
| Long Phone | (###) ###-#### x9999 | Long telephone number mask, |
| Number | | including telephone extension, |
| | | e.g., (555) 555-5555 x5555 |
| Zip Code | ##### | Zip code mask, e.g., 90210 |
| Nine Digit Zip | #####-9999 | Nine digit zip code mask, |
| Code | | e.g., 02346-1043 |
| Scientific | #.###E### | Scientific notation, mask, e.g., |
| | | 1.234E−42 |
| IP Address | 999.999.999.999 | IP address mask, e.g., |
| | | 255.255.255.0 |

In accordance with the invention, the program developer can configure the input mask such that one or more locations within the input mask can only receive a particular character type. During run-time, if the program user tries to enter a different character type at the respective location, the different character type will not be accepted by the masked edit program object, which may also issue an error event. The program developer configures the input mask by placing specially-defined characters at the desired location(s) of the input mask. The following table specifies the specially-defined characters and their meaning as recognized and applied by the masked edit control of the present invention.

TABLE 2

| Character | Meaning |
|---|---|
| # | A placeholder for a required integer or digit of the mask, e.g., |
| | 0 through 9 |
| 9 | A placeholder for an optional integer or digit of the mask, |
| | e.g., 0 through 9, which may be filled with a trailing zero, if |
| | left unfilled by the program user |
| 0 | A placeholder for an optional integer or digit of the mask, |
| | e.g., 0 through 9, which may be filled with a leading zero, if |
| | left unfilled by the program user |
| A | A placeholder for a required letter of the mask, e.g., A |
| | through Z, which will be converted to upper case |
| a | A placeholder for a required letter of the mask, e.g., a through |
| | z, which will be converted to lower case |
| C | A placeholder for an optional letter of the mask, e.g., A |
| | through Z, which will be converted to upper case |
| c | A piaceholder for an optional letter of the mask, e.g., a |
| | through z, which will be converted to lower case |
| z | A placeholder for a required letter of the mask, e.g., A |
| | through Z and a through z, which will remain in the same case |
| | as entered by the program user |
| ? | A placeholder for a required alphanumeric character of the |
| | mask, e.g., 0 through 9, A through Z and a through z |
| & | A placeholder for a required character within ANSI set num- |
| | bers 32-126 and 128-255 |
| . | A literal for masking purposes |
| , | A literal for masking purposes, typically used as a thousand |
| | separator |
| : | A literal for masking purposes, typically used as a time sepa- |
| | rator |
| / | A literal for masking purposes, typically used as a date sepa- |
| | rator |
| \ | Indicates that the next character in the mask is to be treated as |
| | a literal |
| > | Convert all of the characters entered by the user flowing this |
| | point in the mask to uppercase |
| < | Convert all of the characters entered by the user following this |
| | point in the mask to lowercase |
| } | Convert the next character entered by the user following this |
| | point in the mask to uppercase |
| { | Convert the next character entered by the user following this |
| | point in the mask to lowercase |

Suppose the program developer wishes to have the masked edit program object corresponding to icon 922 receive a date from the program user during run-time. Suppose further that the program developer wants to have leading zeros entered in those locations in which the user does not enter any data. For example, if the user enters “9” for the month, the program developer wants the masked edit program object to output “09”. In this case, the program developer preferably selects the standard date mask, e.g., ##/##/####, from the list box 958. In response, the program object copies this mask into the input mask field 956. Rather than accept the pound symbol, i.e., “#”, at each location of the input mask, which requires the program user to enter a digit at that point, the program developer modifies the input mask by replacing each of the pound symbols with a “0”. As mentioned above, the masked edit program object treats a “0” in the input mask as an optional digit placeholder that will be filled in with leading zeros, if left empty by the program user. The input mask is thus set to “00/00/0000” by the program user. The program developer also places a check in box 970, thereby setting the masked edit program object's InsertZeros property to true.

Suppose further that the program developer wants to allow the program user to enter those literal characters that appear within the input mask as the user enters information into the input mask. The selected input mask, i.e., “00/00/0000”, has two literals, namely the two forward slash symbols. In this case, the program developer places a check in box 972, thereby setting the masked edit program object's AllowLiteralEntry property to true.

To run the program represented by flow diagram 930 (FIG. 9C), a user can select the play or run button 912a. In response, the program development environment 310 generates and displays a run-time user input form.

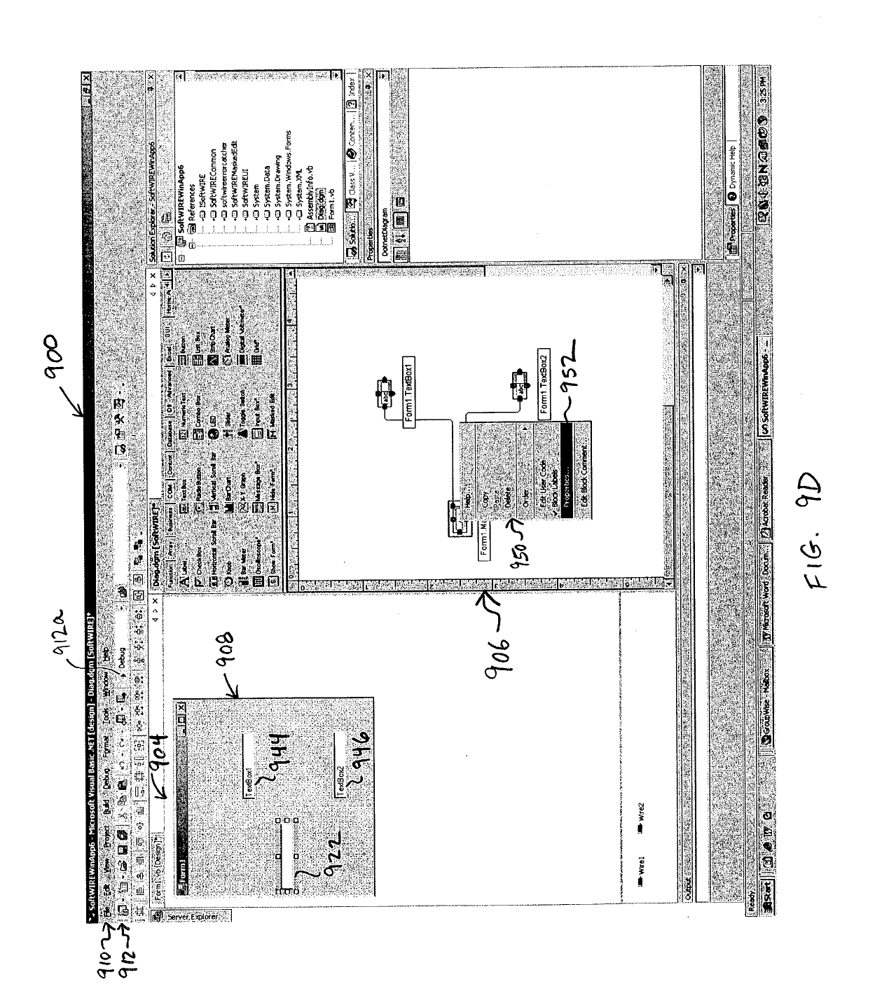

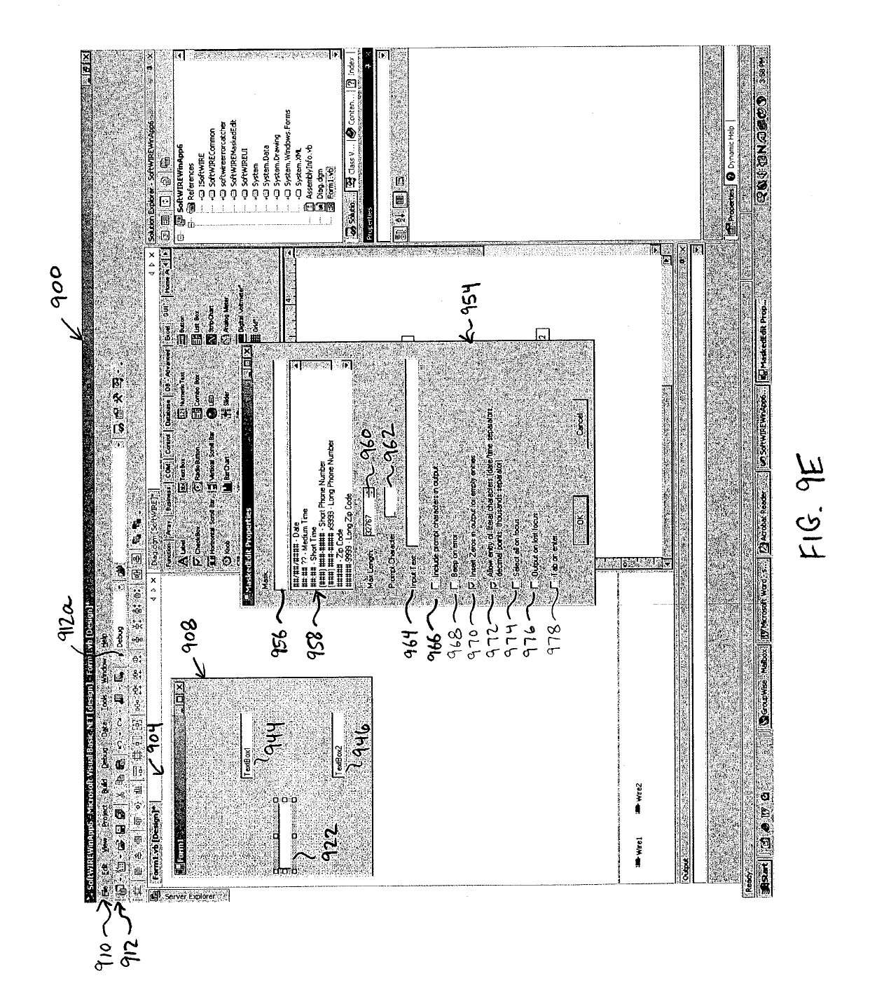

FIGS. 10A-I are highly schematic illustrations of a run-time form generated by the underlying program development utility, e.g., Visual Studio .NET, for the program represented by flow diagran 930 (FIG. 9C). Referring to FIG. 10A, the run-time form 1000 has a masked edit data entry field 1002 for receiving user input data, a first text box display field 1004 for displaying information to the user, and a second text box display field 1006 for displaying information to the user. The masked edit data entry field 1002 uses the underline symbol “_” as a prompt character in each place where an entry from the program user is expected. The masked edit program object causes the data entry field 1002 to display the entire mask, i.e., “______”. The displayed mask in data entry field 1002 does not include the “0” symbols, because they were used to in defining the input mask. The first text box display field 1004, whose properties were not modified during program development, displays “TextBox1”, while the second text box display field 1006, whose properties were similarly left unmodified, displays “TextBox2”.

In the illustrative embodiment, the default values for the masked edit program object's AcceptedText and MaskedText properties is an empty string, e.g., “ ”.

Suppose the date to be entered is Jan. 2, 2002. Rather than having to type a “01” within the first two spaces in order to represent January, the program user can simply enter a “1”. In response, the masked edit program object first determines whether the input value, e.g., “1”, is a valid entry, given the current cursor location within the input mask. Here, the cursor is located at the first entry of the input mask, i.e., at the leftmost location. As described above, the first entry of the input mask is the specially-defined character “0” which is an optional placeholder for a digit. Because the program user indeed entered a digit at this location, namely a “1”, it is accepted as a valid entry by the masked edit program object. FIG. 10B shows how the masked edit program object responds to the user's entry of a “1” during run-time. Specifically, the masked edit program object causes the validly entered digit, i.e., “1”, to be displayed at the location in which it was entered by the user, i.e., the first or leftmost entry of the input mask. The masked edit program object also responds by updating the values of its MaskedText and its AcceptedText properties in response to the input data received from the program user.

Specifically, the masked edit program object set its MaskedText input property to “01/00/0000”. That is, the masked edit program object inserts a leading zero ahead of the “1” entered by the program user. Nonetheless, because masked edit data entry field 1002 continues to have focus, it displays “1______”, i.e., what the program user entered without any leading zeros filled in. The masked edit program object also sets its AcceptedText property to “1”, i.e., the value received from the program user. After updating the values of its MaskedText and AcceptedText properties in response to receiving the user input, the masked edit program object fires its DataReady event. In response to the DataReady event, the two wires coupled to the masked edit program object's output pins get the values associated with those pins and copy those values to the program objects to which the two wires are coupled, i.e., the two text box program objects.

That is, the first wire, which is coupled to the masked edit icon's Masked Text pin 924c (FIG. 9B), gets the current value of the masked edit program object's MaskedText property, i.e., “01/00/0000”, and passes this value to the input pin 934 of the first text box icon 932. In response, the first text box program object causes this received valued to be displayed in the first text box display field 1004. The second wire, which is coupled to the masked edit icon's Accepted Text pin 924d, gets the current value of the masked edit program object's AcceptedText property, i.e., “1”, and passes this value to the input pin 940 of the second text box icon 938. In response the second text box program object causes this received value to be displayed in the second text box display field 1006.

As indicated above, the input mask defined for the masked edit program object had the specially-defined “0” symbol at the first entry or location of the input mask. The specially-defined “0” symbol, moreover, is an optional placeholder for a digit that causes leading zeros to be entered into empty entries of the input mask. Accordingly, had the program user entered something other a digit, e.g., the letter “B”, in the first or leftmost entry of the mask, the masked edit program object would not have accepted such non-digit entry by the program user, and may have also issued an error event. Furthermore, if the Beep on error check box 968 had been checked, thereby setting the masked edit program object's BeepOnError property to true, the masked edit program object would have further caused a beep to be played back to the program user, thereby notifying the program user of the improper entry attempt.

After accepting the “1” from the program user, the masked edit program object causes the cursor to move to the second location in the input mask. The masked edit program object then waits for the next user input. As indicated above, the second location of the input mask was also configured with the specially-defined “0” symbol. Thus, the masked edit program object is once again optionally looking for a digit to be entered by the program user. However, rather than entering another digit, the program user instead enters the forward slash symbol, i.e., “/”. In accordance with the present invention, upon determining that the user input does not match the expected input for the current location of the input mask, the masked edit program object determines whether its AllowLiteralEntry property is set to TRUE or FALSE. As indicated above, in this case, the masked edit program object's AllowLiteralEntry property is set to TRUE. Accordingly, the masked edit program object determines whether the unexpected input corresponds to a literal, e.g., a data/time separator, a decimal point or a thousands separator. Here, the user entry corresponds to the date/time separator, and thus the masked edit program object recognizes the “/” symbol as inputted by the program user at the second location of the input mask as a literal. In response to detecting the entry of a literal and determining that the object's AllowLiteralEntry property is set to TRUE, the masked edit program object responds to the user's entry of the “/” symbol by searching the input mask in a direction to the right from the current entry for a “/” symbol. In this case, the program object finds forward slash symbol 1008 (FIG. 10B). Upon identifying the forward slash symbol 1008, in the input mask, the. masked edit program object causes the cursor to skip over any entries of the input mask between its current location and the location of the “1” symbol, and move to the location of input mask entry that is immediately to the right of the “1” symbol that was located, as shown in. FIG. 10C.

In other words, with the present invention, the masked edit program object can accept the entry of a literal from the program user even though it is expecting to receive some other character given its current location within the input mask. Furthermore, the is masked edit program object responds to the entry of a literal by jumping to the location immediately to the right of the entered literal, skipping over any entries in between its current location and the location to the right of the literal entered by the user.

As indicated above, in moving the cursor to the location to the right of the “/” symbol 1008, the masked edit program object skipped over the second location or entry of the input mask. Furthermore, the input mask of the masked edit program object was configured with the specially-defined “0” character at each data entry position, including the first two entries of the input mask. Upon moving the cursor to the new location, namely, the third entry of the input mask, the masked edit program object detects an empty entry at the second location of the input mask. Accordingly, the program object determines whether its InsertZeros property is set to TRUE or FALSE. As indicated above, in this example, the object's InsertZeros property is set to TRUE. Because of this condition and because the first two entries of the input mask were configured with the specially-defined “0” symbol, the masked edit program object responds to the detection of an empty second entry by entering a leading zero ahead of the “1” thereby moving the “1” to the second location of the input mask. Accordingly, upon entering the forward slash symbol, the masked edit data entry field 1002 now displays “01/______” and the cursor is positioned to the right of the first “/” symbol of the input mask.

The masked edit program object also updates its MaskedText and AcceptedText properties in view of the new user input, i.e., the “/” symbol. In particular, with the insertion of leading zeros, the masked edit program object sets its MaskedText property to “01/00/0000”, overwriting the prior value of this property. The masked edit program object also sets is AcceptedText property to “01”, because the masked edit program object was configured to insert leading zeros in each empty entry of the input mask. Upon updating its MaskedText and AcceptedText properties, the masked edit program object fires its DataReady event. As explained above, the wires coupled to the masked edit icon's two output pins respond by getting the current values of these properties and passing those values to the first and second text box program objects. The first and second text box program objects cause the received information to be displayed in the first and second text box data entry fields 1004 and 1006.

With the cursor at the third entry of the input mask, i.e., the location to the immediate right of the first “/”, the user may next enter a “2”. This third entry of the input mask was also programmed with the specially-defined “0” symbol. Thus, the masked edit program object is expecting to receive an optional digit at this location, which is just what the masked edit program object receives. Accordingly, it responds by displaying the “2” in the current location, i.e., the third entry of the input mask, as shown in FIG. 10D. The masked edit program object also once again updates its MaskedText and AcceptedText properties now that it has received yet another input from the program user. Specifically, the masked edit program object sets its MaskedText property to the current value of the input mask including filled in zeros, namely “01/02/0000”. However, because the masked edit data entry field 1002 continues have focus, it displays “01/2______”. That is, no leading zero is entered ahead of the “2”. The masked edit program object also sets the value of its AcceptedText property to the current set of input data and leading zeros, if any. At this point, the current set of input data from the program user and leading zeros is “012”. The masked edit program object then fires its DataReady event, causing the values of these two properties to be passed to the two text box program objects for display in the two text box display fields 1004 and 1006 as shown in FIG. 10D.

The masked edit program object also causes the cursor to advance to the next entry in the input mask, i.e., the fourth entry. Suppose that the program user enters another forward slash symbol, i.e., “/” at this entry of the input mask. Again, the masked edit program object is expecting to receive an optional digit from the program user, because the fourth entry of the input mask was configured with the specially-configured “0” symbol. Nonetheless, because its AllowLiteralEntry property is set to TRUE, does not treat the “/” as an invalid entry. Instead, the masked edit program object responds by searching from its current location to the right of the input mask for a “/” symbol, which was the literal entered by the program user. In this case, the masked edit program object finds the second forward slash symbol 1010 (FIG. 10E), and causes the cursor to be moved to the space to the right of this “/” symbol 1010, as shown, skipping any entries in between its current location and the new location. With the cursor to the right of the second “/” symbol 1010 in the input date mask, the masked edit program object detects that the fourth entry of the input mask is empty. More specifically, the user only entered a “2” at the third entry of the mask, then entered the forward slash literal causing the fourth entry of the input mask to be skipped. Because the masked edit program object was configured with its InsertZeros property set to TRUE and the third and fourth entries of the input mask were programmed with the specially-defined “0” symbol, which causes the entry of leading zeros, the masked edit program object responds to the detection of the empty entry by moving the “2” to the fourth entry of the input mask and placing a leading zero in front of the “2” in the third entry. Accordingly, the masked edit data entry field 1002 displays “01/02/______” and the cursor is now located at the fifth entry of the input mask.

The masked edit program object also updates the values of its MaskedText and AcceptedText properties in response to the user having entered the literal. Specifically, the masked edit program object sets its MaskedText property to the current form of the input date mask, i.e., “01/02/______”. It also sets the value of its AcceptedText property to the data entered by the program user along with any inserted zeros, i.e., “0102”. The masked edit program object then fires its DataReady event, causing the current values of its MaskedText and AcceptedText properties to be passed to the two text box program objects. Accordingly, the first text box field 1004 now displays “01/02/0000”, while the second text box field 1006 displays “0102”. As shown, even though the program user has not entered a single “0” character into the input mask at this point, the masked edit data entry field 1002 displays two “0” symbols, one in front of the “1” and the other “0” in front of the “2”. Furthermore, the data passed to the second text box program object, “0102”, includes two zeros. Such operating characteristics were achieved by setting the masked edit program object's InsertZeros property to TRUE, and by configuring the input date mask with the specially-defined “0” symbol.

With the cursor starting at the fifth entry of the input mask, suppose the program user enters the characters “2”, “0”, “0”, and “2”. Each of these characters is recognized as data, not as literals. Each entry is also considered a valid entry because the corresponding locations of in the input mask were set to the specially-defined “0” symbol. Accordingly, the masked edit program object displays these values in the spaces or locations at which they were entered within the masked edit data entry field 1002, as shown in FIGS. 10F-10I. The masked edit program object also updates its MaskedText and AcceptedText properties and fires its DataReady event in response to each entry by the program user. Accordingly, the newly entered characters are passed to and received at the two text box program objects, and displayed in the two text box fields 1004, 1006.

To prevent the masked edit program object from triggering upon each user input, the program developer could have set the masked edit program object's OutputOnLostFocus property to TRUE. In this case, the masked edit program object would not update its MaskedText and AcceptedText properties until the masked edit data entry field 1002 lost focus, e.g., until after the program user had entered the desired values and moved to some other data entry field. Once the masked edit data entry field 1002 lost focus, the masked edit program object would set its MaskedText and AcceptedText properties along with any leading zeros as appropriate, and fire its DataReady event. This result could also have been achieved by wiring the masked edit icon's control in terminal 924b. In this case, the masked edit program object would hold off on updating its MaskedText and AcceptedText properties and/or on firing its DataReady event until it both received at least one input from the user and its Controlln property was modified.

Suppose that instead of programming each location in the date input mask with the specially-defined “0” symbol (which is a placeholder for an optional digit and further results in the insertion of leading zeros as described above), the program developer configures the date mask with the specially-defined “9” symbol at each location. That is, the program developer, manipulates the property page 954 (FIG. 9E) of the masked edit program object, selects the date input mask from the list box 958, but changes its default setting from “##/##/####” to “99/99/9999”. As explained above, the masked edit program object treats the appearance of the specially-defined “9” symbol in an input mask as a placeholder for an optional digit, i.e., the numerals 0-9, and if such an entry is left empty, it is filled with trailing zeros.

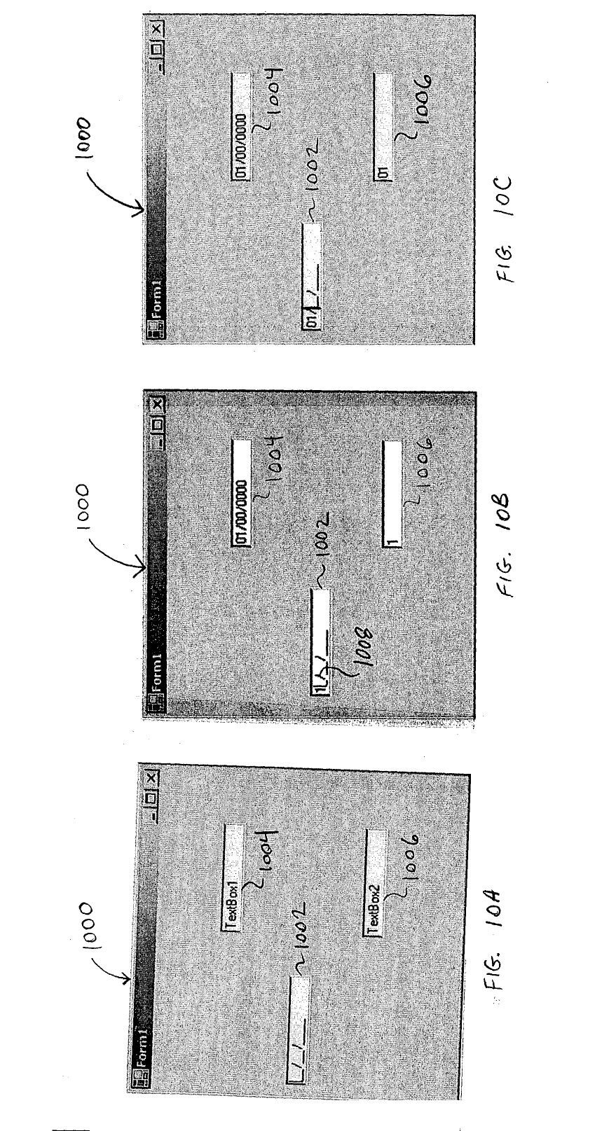

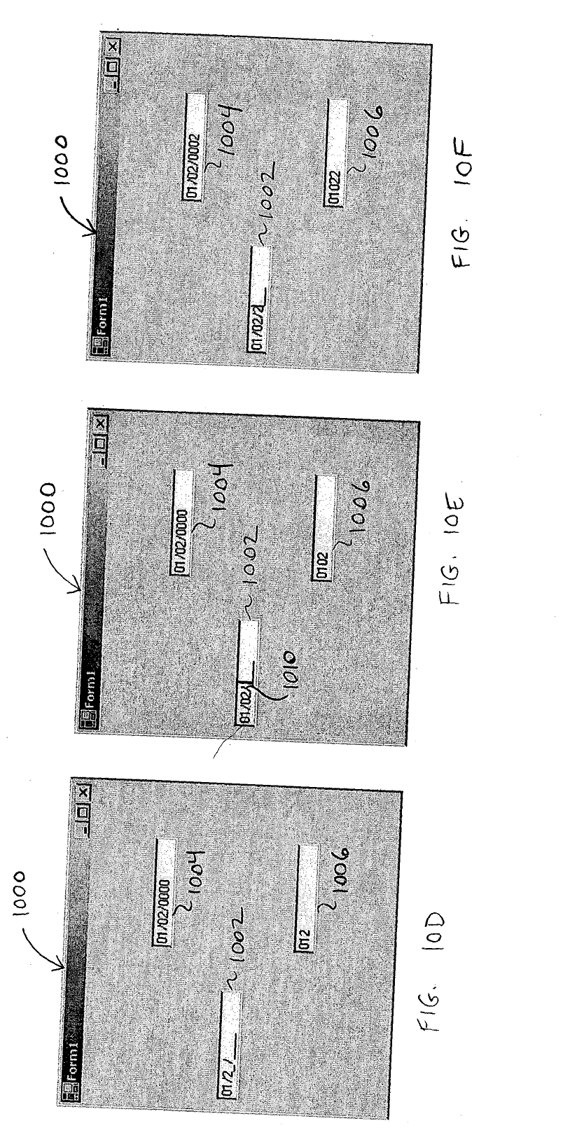

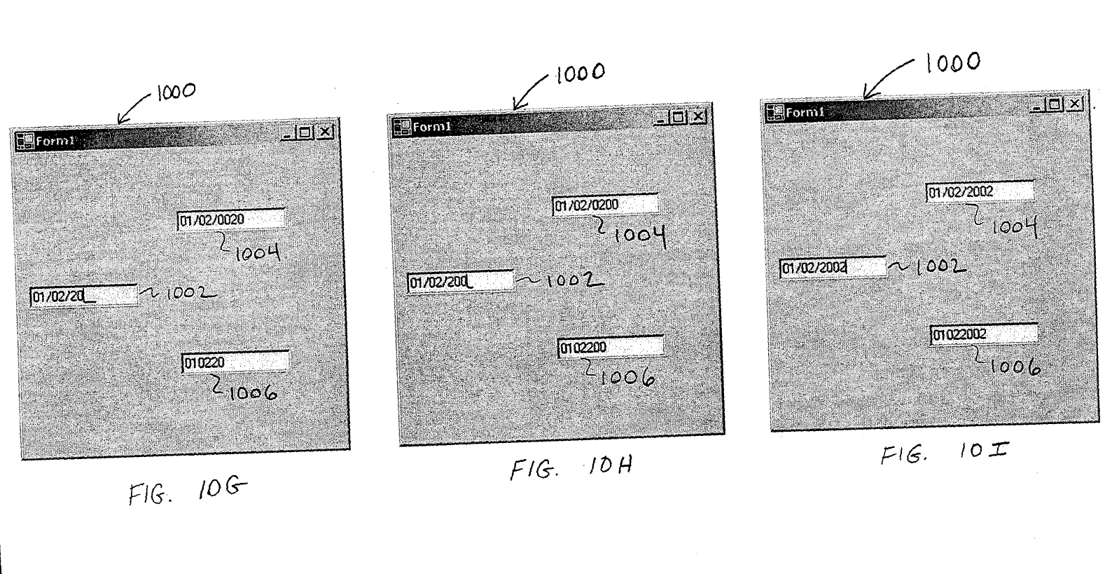

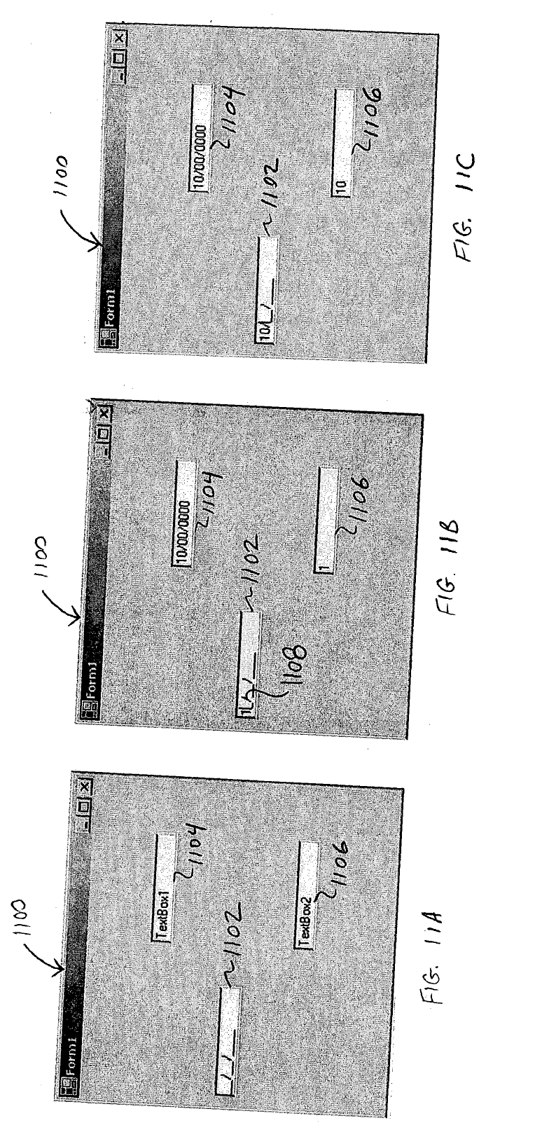

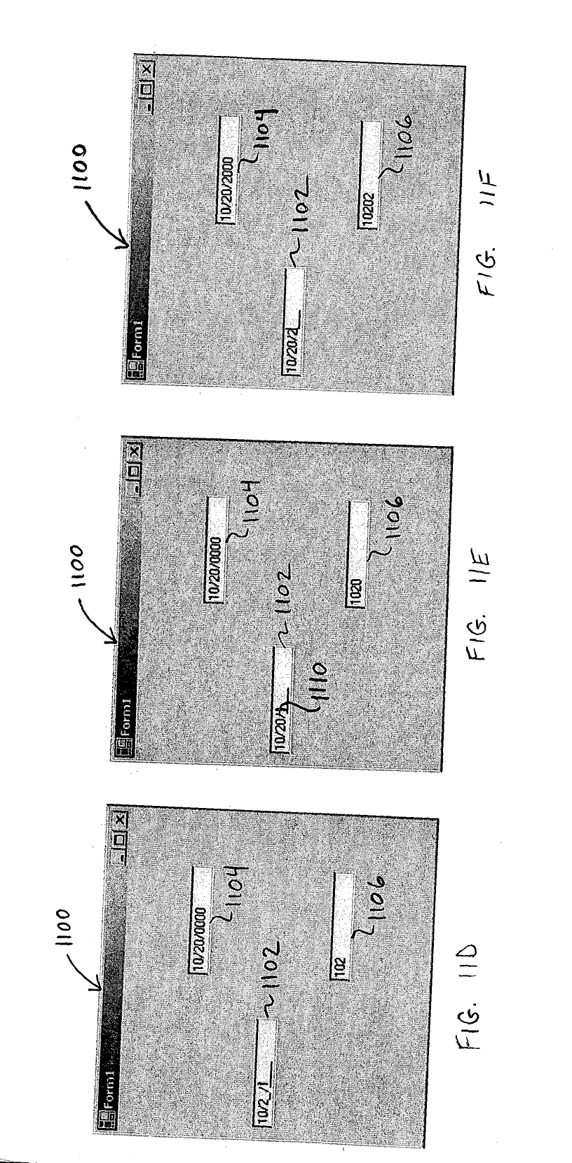

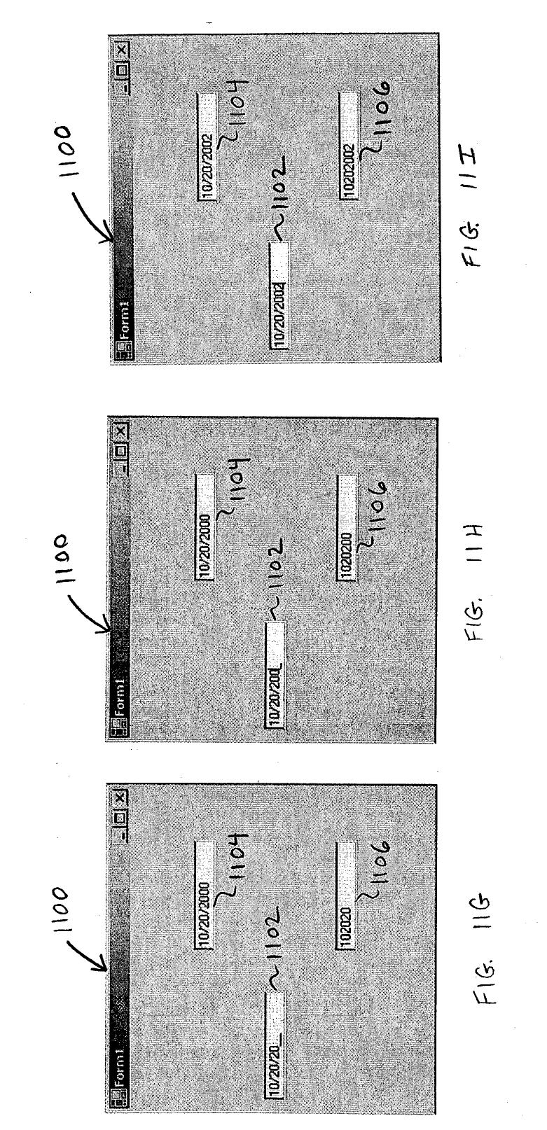

FIGS. 11A-I are highly schematic illustrations of a run-time form 1100 generated by the Visual Studio NET program development environment based on flow diagram 930 (FIG. 9C). In this case, however, with the input mask of the masked edit program object corresponding to icon 920 is configured with an input mask of “99/99/9999”. Referring to FIG. 11A, the run-time form 1100 has a masked edit data entry field 1102 for receiving user input data, a first text box display field 1104 for displaying the information associated with the masked edit program object' MaskedText property value, and a second text box display field 1106 for displaying the object's AcceptedText property value. As was the case with the run-time form 1000 illustrated in FIGS. 10A-I, the masked edit data entry field 1102 uses the underline symbol “_” as a prompt character in each place where an entry from the program user is expected.

To illustrate the operation of the masked edit program object, suppose the user again enters the following sequence of characters “1/2/2002”. FIG. 11B shows the run-time form 1100 after the user has entered a “1” in the first, i.e., the leftmost, entry of the masked edit data entry field 1102. This placeholder of the input mask was configured with the specially-defined “9” symbol, which is an optional placeholder for a digit. The masked edit program object thus considers the user's entry of a “1” at this location to be a valid entry and accepts that user input value. The masked edit program object causes the “1” to appear in the masked edit data entry field 1102 in the location where it was entered. The masked edit program object also responds to receiving user input by modifying its MaskedText property value and its AcceptedText property value. Specifically, the masked edit program object sets its MaskedText property to the current format of the entire input mask including the received digit, i.e., “10/00/0000”. The masked edit program object sets its AcceptedText property to the information entered by the user and inserted zeros, if any, i.e., “1”. After updating these property values, the masked edit program object fires its DataReady event. In response, the two wires coupled to the masked edit program object's output pins get the current values of the object's MaskedText and AcceptedText properties, and moves those values to the input pins of the program objects to which the wires are connected, i.e., the first and second text box program objects.

That is, the first wire passes the information from the masked_text output pin, i.e., “10/00/0000”, to the input pin of the first text box program object. In response, the first text box program object causes this received information to be displayed in the first text box display field 1104. The second wire passes the information from the accepted text output pin, i.e., “1”, to the input pin of the second text program object. In response the second text box program object causes this received information to be displayed in the second text box display field 1106. The masked edit program object also causes the cursor to move to the second location of the input date mask.

With the cursor at the second location of the input date mask, the program user enters the forward slash symbol, i.e., “/”. Because this location of the input mask was configured with the specially-defined “0” symbol, the masked edit program object is expecting to receive a digit from the user. Before rejecting the user's non-digit input and issuing an error event, the program object determines whether its AllowLiteralEntry property is set to TRUE, which it is in this example. In response, the masked edit program object searches the input date mask moving from its current location, i.e., the second entry, to the right searching for the literal entered by the user, i.e., the forward slash symbol. The masked edit program object finds forward slash symbol 1108 (FIG. 11B), and causes the cursor to be moved to the space immediately to the right of the located “/” symbol skipping over any empty entries of the input date mask, as shown in FIG. 11C.

In addition, because the entry of the literal, i.e., the “/” symbol by the user caused the masked edit program object to skip an entry in moving to the space immediately to the right of the located “/” symbol, i.e., the second entry of the input mask and because the masked edit program object was configured with the specially-defined “9” symbol at each location within the input mask, the masked edit program object enters trailing zeros in the empty spaces of the input mask that are located to the left of the “/” symbol 1108. In this case there was only one empty space to the left of the “/” symbol 1008. Accordingly, the masked edit data entry field 1102 now displays “10/______”. The masked edit program object also updates its MaskedText and AcceptedText properties in response the user input. In particular, the masked edit program object sets its MaskedText property value to the entire mask in its current form, i.e., “10/00/0000”. The masked edit program object also sets its AcceptedText property to the user input plus any inserted zeros, i.e., “10”. Upon updating the information at its output pins, the masked edit program object fires its DataReady event. As explained above, the wires coupled to the object's two out-put pins respond by getting the current values of the object's MaskedText and AcceptedText properties and passing those values to the first and second text box program objects. The first and second text box program objects cause the received values to be displayed in the first and second text box data entry fields 1004 and 1006.

With the cursor at the location to the immediate right of the first “/” in the masked edit data entry field 1002, the user next enters a “2”. The masked edit program object was expecting to receive a digit at this entry of the input mask, as it was configured with the specially-defined “9” symbol. Accordingly, the masked edit program object accepts the user input as a valid input, displays the “2” in the current location, i.e., the third entry of the input mask, and moves the cursor to the fourth entry of the input mask, as shown in FIG. 11D. The masked edit program object also updates the values of its MaskedText and AcceptedText property values. Specifically, the masked edit program object sets its MaskedText property to the current form of the entire date mask, namely “01/20/0000”. The masked edit program object also sets the value of its AcceptedText property to the entries entered by the user plus any trailing zeros, i.e., “102”. The masked edit program object then fires its DataReady event, causing the current values of its MaskedText and AcceptedText properties to be passed to the two text box program objects for display in the two text box display fields 1004 and 1006 as shown in FIG. 10D.

With the cursor now at the fourth entry of the input mask, the program user enters another forward slash symbol, i.e., “/”. Again, even though the user entry is not a digit, it is accepted by the masked edit program object as a valid entry because it is a literal, and the masked edit program object's AllowLiteralEntry property is set to TRUE. Accordingly, the masked edit program object searches the input mask to the right of the current cursor location for the literal entered by the program user, i.e., a “/” symbol. In this case, the masked edit program object finds the second forward slash symbol 1110 (FIG. 10E), and causes the cursor to be moved to the space to the right of this “/” symbol 1110 skipping any entries of the input mask in between the cursor's current location and the location to the right of the entered literal. Now that the cursor is to the right of the second “/” 1110 in the date input mask, the masked edit program object detects that the fourth entry of the input mask is empty. More specifically, the user entered a “2” at the third entry of the input mask and then caused the cursor to be moved to the fifth entry by entering the forward slash literal. Because the masked edit program object was configured to insert zeros in empty entries, and the masked edit was programmed with the specially-defined “9” symbol which causes the entry of trailing zeros, the masked edit program object responds to the detection of the empty entry by placing a zero in the fourth entry of the date input mask. Accordingly, the masked edit data entry field 1002 displays “10/20/______”.

The masked edit program object also updates its MaskedText and AcceptedText property values in light of the additional user input. Specifically, the masked edit program object sets the value of its MaskedText property to the current form of the date input mask, i.e., “10/20/______”. The masked edit program object sets the value of its AcceptedText property to the inputs entered by the program user along with any inserted zeros, i.e., “1020”. The masked edit program object then fires its DataReady event, causing the current values of its MaskedText and AcceptedText properties to be passed to the two text box program objects. Accordingly, the first text box field 1004 now displays “10/20/0000”, while the second text box field 1006 displays “1020”. Again, even though the program user has not entered a single “0” character at this point, the masked edit data entry field 1002 displays two “0” symbols, one behind the “1” and the other “0” behind the “2”. Furthermore, the data passed to the second text box program object, “1020”, includes two zeros. Such operating characteristics were achieved by setting the masked edit program object's InsertZeros property to TRUE, and by entering the specially-defined “9” in the entries of the date mask.

With the cursor starting at the fifth entry of the date input mask, suppose the program user now enters the characters “2”, “0”, “0”, and “2”. As each of last four entries of the input date mask was configured with the specially-defined “9”, the masked edit program object accepts the entered digits as valid entries. Accordingly, the masked edit program object displays these values in the spaces or locations at which they were entered within the masked edit data entry field 1102, as shown in FIGS. 11F-10I. The masked edit program object also updates the values of its MaskedText and AcceptedText properties following each user input. Upon updating its property values, the masked edit program object also fires its DataReady event. Accordingly, each time the user enters a new input, the newly computed values for the masked edit program object's MaskedText and AcceptedText properties are passed to and received at the two text box program objects, and displayed in the two text box fields 1104, 1106.

If the program developer sets the masked edit program object's AllowLiteralEntry property to FALSE, then the masked edit program object will not accept the entry of literals by the program user. Specifically, suppose the program developer un-checks check box 972 (FIG. 9E), which sets the objects AllowLiteralEntry property to FALSE. Suppose further that the input date mask is set to “00/00/0000” as described above in connection with FIGS. 10A-I. After entering the “1” at the first entry of the input mask, the cursor moves to the second entry. The masked edit program object, moreover, expects to receive an optional digit at this entry. When the user enters the forward slash literal instead, the masked edit program object checks to set whether its AllowLiteralEntry property is set to TRUE. In this example, the AllowLiteralEntry is set to FALSE. In this situation, the masked edit program object responds to the user's input of the “/” literal as an error and does not accept the entry of the “/”. That is, the masked edit program object does not search the input mask for the next “/” and does not move the cursor past its current location, i.e., the second entry of the input mask. If the masked edit program object's BeepOnError property is TRUE, the masked edit program object causes a beep sound to be played back informing the program user that an invalid entry was attempted. To move the cursor to the third entry of the date input mask, the program user must either enter a valid entry at the second entry, i.e., a digit, or using the mouse or the keyboard's arrow keys, manually move the cursor to the third entry of the input date mask.

If the program user moves the cursor manually to the third entry of the input date mask and enters a valid input, i.e., a digit, the masked edit program object accepts that input and places the entered digit at the third entry of the input mask.

It should be understood that the masked edit program object may be provided with additional properties that can be set by the program developer at design time. For example, the masked edit program object may include an EnableToolTip property that can be set to TRUE or FALSE, and a ToolTipText property that can be set to a selected string. If the masked edit program object's EnableToolTip property is TRUE, then at run-time, a tool tip will popup on the display screen whenever the program user positions the cursor over any part of the masked edit data entry field 1002. This popup tool tip, moreover, will display the value of the masked edit program object's ToolTipText property, e.g., “Enter the 10-digit phone number here”.

The masked edit program object may also include a number of different properties regarding the manner in which numbers are accepted or displayed. For example, the masked edit program object may include a NumberCategory property that can be set to one of a plurality of predefined number formats, such as those utilized in Microsoft® Excel, e.g., General, Number, Currency, Date, Time, Percentage, Fraction or Scientific. Depending on the particular number category that is selected, other properties may then become available for setting by the program developer. If the Fraction category is selected, the program developer may then be able to set a FractionTypeValues property, which is used to specify the desired format of fractions, such as one-digit fractions, e.g., 1/2, two-digit fractions, e.g., 12/15, quarters, e.g., 2/4, eighths, e.g., 6/8, etc. Selection of the Date category may similarly allow the program developer to set a DateTypeValues property to specify the desired date format. A Use1000Separator property if set to TRUE will include a comma in the masked text as a thousands separator. A NegativeNumbers property can be set to specify the format of negative numbers, e.g., with a minus sign, in red without a minus sign, in parentheses, etc. In addition, corresponding property pages may be provided during design time to facilitate the setting of these properties. Those skilled in the art will recognize that other such properties can be defined for the masked edit program object to facilitate application program development.

The foregoing description has been directed to specific embodiments of this invention. It will be apparent, however, that other variations and modifications may be made to the described embodiments, with the attainment of some or all of their advantages. For example, the TRUE/FALSE settings of the masked edit program object's properties may be reversed to achieve the described operating characteristics. Therefore, it is the object of the appended claims to cover all such variations and modifications as come within the true spirit and scope of the invention.

What is claimed is:

1. A masked edit program object for use with a graphical programming environment, the masked edit program object comprising:
a graphical icon representing the masked edit program object for display in a diagramming window of the graphical programming environment;
an input mask that includes one or more literals for use in suggesting to a program user the type of information to be entered in the masked edit; and
a first property that is settable by a program developer between one of asserted and de-asserted;
wherein, at run-time, the masked edit program object accepts the entry of a literal by the program user as a valid entry provided that the first property is asserted.

2. The masked edit program object of claim 1 further comprising:
a second property that corresponds to a current value of the input mask including valid user entries and literals; and
a third property that corresponds to a current set of valid user entries.

3. The masked edit program object of claim 2 further comprising:
a fourth property that is settable by a program developer between one of asserted and de-asserted, wherein
the masked edit program object inserts zeros into empty entries of the input mask provided that the fourth property is asserted.

4. The masked edit program object of claim 3 wherein the second and third properties further include inserted zeros, provided that the fourth property is asserted.

5. The masked edit program object of claim 4 wherein one or more entries of the input mask are configured and arranged with a specially-defined symbols, including a first specially-defined symbol that is a placeholder for an optional digit that is filled with leading zeros if left empty by the program user and the fourth property is asserted.

6. The masked edit program object of claim 5 wherein a second specially-defined symbol is a placeholder for a optional digit that is filled with trailing zeros if left empty by the program user and the fourth property is asserted.

7. The masked edit program object of claim 6 wherein
the first property is called AllowLiteralEntry;
the second property is called MaskedText;
the third property is called AcceptedText; and
the fourth property is called InsertZeros.

8. The masked edit control of claim 1 wherein asserted is TRUE and de-asserted is FALSE.
